(19) United States
(12) Patent Application Publication
(10) Pub. No.: US 2006/0287024 A1
(43) Pub. Date: Dec. 21, 2006

(54) Cricket conditions simulator

(76) Inventors: Charles Laughton Griffith, Grand Prairie, TX (US); Edward Frederick Cummings, Dallas, TX (US)

Correspondence Address: CHARLES L. GRIFFITH;# 112, 204 NORTH MAIN STREET, DUNCANVILLE, TX, 75116, US

(21) Appl. No.: 11/152,218

(22) Filed: Jun. 15, 2005

(51) Int. Cl. A63F 13/00; G06F 19/00

(52) U.S. Cl. 463/3; 434/247

(57) ABSTRACT

The cricket conditions simulator is an educational development system for cricketers and coaches, with means of simulating a plurality of outdoor cricket competition conditions relative to cricket pitch scenarios during practice sessions, by utilizing specially designed building structures equipped with capabilities to simultaneously create a plurality of outdoor temperatures and relative humidity, illumination, visual and spectator cultural sounds as distractions, wind speeds, means to record cricketers' performances, cricket pitch deterioration and cricket ball aerodynamics; and a heat exchanger equipped with pressure, moisture content and thermal sensors located within the cricket pitch to modify cricket pitch conditions. Designed activities in the simulator build mental fortitude as a necessary requirement in order to bat, field and bowl under different environmental and cricket pitch conditions for extended periods; and therefore reduces the magnitude of the learning curve to understand cricket ball, pitch and bowler relationships, for the least possible cost and time.

### CROSS REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION

### Field of the Invention

This invention relates to a cricket conditions simulator which operatively provides real time information and simultaneously reproduces outdoor cricket playing environment and cricket pitch conditions by respectively using an air conditioning system, high luminous intensity lighting system, high powered industrial fans in a plurality of coupled array, high powered stereophonic system, means of visual and other sensual distractions, a plurality of high sensitivity cameras with slow motion and high resolution magnification zoom capabilities; a plurality of micro atomizers for outdoor climate modifications; and means for adsorption and desorption relative to cricket pitch surface and subsurface rheological, textural, capillary, shrinkage, moisture equivalent, volume change, thermal constants and thermodynamic properties for a plurality of cricket pitch conditions. More particularly this invention is a cricket conditions simulator to be utilized as an educational device for coaches, cricket administrators who wish intense crisis training regimentation for employees under contract, and related personnel. The cricket conditions simulator is especially useful to cricketers who wish aggressive exposure, thereby reducing their learning curve to simultaneous different cricket pitch, distraction and atmospheric conditions, while executing a multiplicity of techniques in batting, fielding and bowling, during practice sessions of the playing environment, from which data could be collected for further detailed scientific analysis, to include conducting real time synthesis, to effect recommendations for instructions and or improvements.

### OTHER REFERENCES

“Drying Rate Cow of Paunch Contents”; Griffith C. L., and Brusewitz, G. H.: Transactions of the American Society for Agricultural Engineers; Vol 23, No 4, pp 1016, 1017, 1018, 1019, 1023; 1980.
“Specific Heat, Thermal Conductivity, Density and Thermal Diffusivity of Mexican Tortillas Dough”; Griffith C. L.; Journal of Food Science; Vol 50, No 5, pp 1333, 1334, 1335, 1336, 1337, 1341; September-October 1985.

### BACKGROUND OF THE INVENTION

Most of the prior art pertaining to heating soil and especially those associated with contaminated soil, are confined to removing hydrocarbon based constituents from contaminated soils and ground water, by either closed loop or open loop technologies, considering extremely high temperature and non thermal means. The literature on previous art on plate heat exchangers is robust, but, with respect to cricket, very little information is published in reputable scientific journals.

U.S. Pat. No. 6,374,910 to Cairenius, and dated September, 1979, described the use of a heat transfer panel, within which a plate heat exchanger termed a conductive sheet is utilized, to heat and cool environment for human comfort. The effective modes of heat transfer to the space to be heated are by convection and radiation. Although ideas embodied in the said invention could be applied to ceiling panels, vegetable and other food related display, for commercial purposes plate exchanger within a configuration, the geometry and design of the said heat transfer panel could not address the circumstances associated with the heating and cooling of a cricket pitch, and therefore has no utility for cricket.

U.S. Pat. No. 5,221,827 to Marsden, Jr., et al. and dated June, 1993 describes a heater blanket for remediation of shallow organic contaminated soils, by combining heating elements encased in ceramic beads, supported by frames, and are constructed in a manner to facilitate vertical movements, to accommodate surface irregularities of the soil under consideration. The heat is transferred to the contaminated soil which essentially volatizes after contact with the heat, then a vacuum is applied to remove the volatized components.

U.S. Pat. No. 5,244,310 to Johnson and dated September, 1993 addresses heating and vapor extraction of contaminated soils by utilizing two sets of spikes which are driven into the ground. One set of spikes is heated to temperatures in excess of 100° C. and the other set is connected to a vacuum system. The heat from those heater spikes supplying heat to the soil are transferred to the soil by conduction, thereby generating volatilization of contaminants which are extracted by the vacuum system through the spikes associated therein.

U.S. Pat. No. 5,271,693 to Johnson, et al. and dated December, 1993 addressed a soil vapor extraction process for removing contaminants from soils located in deep geological and high ground water laden formations, by placing heaters at the depths of the contaminated soils, then utilizing other conduits attached to a pump to remove the condensate formed as result of the applied heat. With respect to ground water considerations, the ground water is drawn down to expose normally saturated soils, before extraction as previously described could be applied.

U.S. Pat. No. 5,229,583 to Von Egmond, et al. and dated July, 1993 comprises an heating assembly with a metallic furnace belt at the bottom, upon which sits a flexible fibrous ceramic insulation, over which an impermeable silicone rubber sheet is placed. This apparatus has the capability of being rolled and dragged over the soil contour to transfer heat to the soil by conduction.

U.S. Pat. No. 5,318,116 to Vinegar, et al. and dated June, 1994 comprises perforated heater wells which imposes a vacuum in the soil, then heats the soil by thermal conduction, after which vaporization and oxidation of the contaminants in the soil occur at low boiling points attributable to low vapor pressures. The collected water vapor can be collected in a cold trap located upstream from the vacuum pump or incinerated in line.

U.S. Pat. No. 5,331,134 to Kimura and dated July, 1994 described a double layered ceramic heater comprising a insulating prolytic boron nitride base plate, and two resistance heater element layers positioned on the upper and lower layer of the said base plate. The heating area traversed by the electric resistance heater element layer where heat is evolved, and a gap area where the resistance heater element is not formed, given the opposite face has an offset complementary heat evolving area, resulted in an improved uniformity in temperature distribution, over the whole surface of the ceramic heater.

U.S. Pat. No. 5,360,067 to Meo, III and dated November 1994 involves a closed-loop, thermal process to address the remediation of soil containing clays and silt and hydrocarbons with relatively high boiling points. This process utilized an extraction well as well as an injection well with the gas from the extraction well used with other heated gas, then injected into the contaminated soil to volatize the hydrocarbons within the contaminated soil medium. Dielectric heating supplemented heating the combustion gases to the desired temperature.

U.S. Pat. No. 5,449,251 to Daily, et al. and dated September, 1995 created a dynamic underground stripping process to include steam injection of volatized contaminants trapped within more permeable soil formations, whereas, direct electrical heating is applied to the impermeable formations the steam could not penetrate. Liquid pumping and vacuum extraction are applied to withdraw the volatized contaminants.

U.S. Pat. No. 5,528,020 to Dickens, et al. and dated June, 1996 described a dual plate heater comprising two parallel temperature self regulating heater plates, with one or a plurality of electrically energized coils parallel to and located between the said heater plates; said coil when energized by a constant current heats the said plates to their Curie temperatures. The dual plated heaters are utilized in plastic weldtment and for dispensing machines.

U.S. Pat. No. 5,553,189 to Stagemeier, et al. and dated September, 1996 describes a radiant heater to function at very high temperatures greater than 900° F., utilizing either electrical or heat from combustible gas to extract contaminants from near surface soils, and other surfaces. The apparatus consists of a heating steel plate which is in contact with the soil beneath, and tubular electrical heating elements attached loosely on the top. The said heating elements are covered by stainless steel reflector plate, over which thermal mineral insulation is placed. Said insulation has a weather proof cover. An embodiment of this invention is to utilize a composite structure for the said heating plate, considering combination of copper, aluminum and stainless steel in a sandwiched manner. Another embodiment in the construction of the said heating plate is the position of long electrical heaters in a parallel manner on each flat surface of the heating plate. The said heating apparatus with metal heating is designed to apply heat to the soil in a compression mode. The said heating apparatus with metal heating plate is not designed to sustain compression from the soil attributed to pressure induced by a plurality of compression rollers traversing the said plate. The said apparatus with metal heating plate is not supported by a plurality of metal plates to add structural reinforcement therein to support heavy compression equipment. The said heating apparatus with metal heating plate is not supported by a plurality of reinforced concrete walls. The said heating apparatus with metal heating plate is not designed to create a surface upon which grass could be cultivated, then strategically manicured for additional utility.

The primary mode of heat transfer during heating at the temperatures, with which this apparatus is operationally functional during normal and optimization modes, is attributable to radiation. The said heating apparatus with metal heating plate is not designed to facilitate the primary mode of heat transfer as conduction. The said apparatus with metal heating plate is constructed with radiant heat reflector and designed to create very high temperature environments for normal utility, considering vaporization of contaminated hydrocarbons trapped within the soil complex.

None of the embodiments herein considered the apparatus with metal heating plate to have a plurality of future technical, economic, and any other known applications at operational temperature less than, and at the boiling point of water at 100° C. The spirit, objective and inferential utility of the said apparatus is pertaining to soil remediation. The apparatus with metal heating plate may be regarded as a surface vaporizer or pyrolizer or decomposer of volatile elements in contaminated soil.

The said apparatus with metal heating plate is not equipped with a plurality of probes to determine the moisture content of the soil with which it is in contact. The said apparatus with metal heating plate is not equipped with a plurality of pressure sensors from which estimates of the warping compressive stresses of material impacting the soil could be determined. The said apparatus with heating plate is not used as a component of a a plurality of training tools or devices for improvement in sports. The apparatus with metal heating plate is not part of a scheme or method or curriculum to contribute to a plurality of improvements of the mental fortitude of the user. The said apparatus with metal heating plate is not part of a simulation device for a plurality of sports improvements and therefore treated as an integral component of an indoor facility. The said apparatus with metal heating plate is not used in conjunction with specialized lighting, sound system, and a plurality of visual distracting devices.

U.S. Pat. No. 5,674,424 to Iben, et al. and dated October, 1996 combines desorption and vacuum extraction to separate hydrocarbons from contaminated soils, resulting in the development of a heating blanket which consisted of surface heating element, thermal insulation, vacuum collection system and vapor barrier. The blanket which consisted of electrically-powered resistive heaters is applied to the top surface of the soil and heat is transferred to the interior of the soil complex by conduction. Water is boiled, semi-organic and volatile compounds are dried.

U.S. Pat. No. 5,584,605 to Beard, et al. and dated December 1996 invented an approach to remediate specific hydrocarbon contaminated soils and groundwater by using sparging pipes within, above and below the contamination medium, so that the sparger gas with associated hydrocarbons is conducted to the surface for hydrocarbon removal.

U.S. Pat. No. 6,374,910 to Tsunoda, et al. and dated April, 2002, addressed two problems associated with the efficiency of conventional combustible gas to air heat exchangers. The problems are leakage about high temperature inlet fluid flow and low temperature outlet fluid flow means, as well as low temperature inlet fluid flow and high temperature outlet fluid flow means; and drifting fluid flow between different flow paths lengths. This invention formed and bent folding plate banks of ends of heat transfer plates, in a complicated geometrical pattern to accommodate a superior brazed surface contact state, in addition to facilitate the construction of combustible gas inlets and air outlets at two end edges of angled shapes. Despite this said invention is centralized around an application of plate exchanger, the spirit, objective, configuration and design of the said combustible gas to air heat exchanger could not address the circumstances associated with the heating and cooling of a cricket pitch, and therefore has no utility for cricket.

U.S. Pat. No. 5,290,904 to Skirakawa, et al. and dated September, 2002 described a heat treatment apparatus table which utilizes an hollow heating plate, a cover assembly with exhaust means and positioned immediately above the said heating plate, a cooling means about the said cover assembly, and means of detecting the temperature of substrate to be treated. The primary heat source is electrical, but hot vapors may be utilized as an heating source. The primary purpose of this invention is to provide heat treatment to semiconductors wafers. Cooling of substrate is by convection and to a mild extent by conduction if the said heater temperature is less than that of the said wafer.

The said heat treatment apparatus table is not designed to experience large compression rollers, as is required to prepare a cricket pitch, given the central section the said heat treatment apparatus table would require extensive additional support to resist the plurality of bending moments, attributed from the weight of the said compression equipment. The heat treatment apparatus table would also require a plurality additional excessive modification to accommodate the multiplicity of thermocouple probes and moisture content sensors. In addition, the positioning of the plurality of strain gages would be extremely difficult since the entire lower section of the said table needs to be removed without replacement, to accommodate maintenance activities for all appurtenances below and associated with the said cricket pitch.

Since water is the primary heating medium for the cricket conditions simulator, in order for the said heat treatment apparatus table to use water as a medium for heating, then a plurality of tubes with or without fins have to be installed on the said heat treatment apparatus table, and secured therein by a plurality of continuous weldments. With respect to positioning thermal resistance insulation on the underside of the said heat treatment apparatus, a need would exist to install the plurality of perimeter support structures around the perimeter of the said heat treatment apparatus, to accommodate a plurality hangers for the said thermal insulation, as well as remove the plurality of cantilever effects on the said heat treatment apparatus, if said the perimeter support structures were not present.

As regards utilizing the said heat treatment apparatus table to retrofit existing cricket pitches, without disturbing the batting or bowling surface, very expensive shoring and specialized excavation would be required, and may well be hazardous to the said surface to achieve that objective, since the said heat treatment apparatus needs to be positioned about 10″ below the surface of the said cricket pitch. With respect to the installation of the said heat treatment apparatus table in new cricket pitches, here again considerable structural modifications as previously discussed is warranted.

Based upon the spirit and objectives of the said invented heat treatment apparatus, and the plurality of modifications as identified herein, for the said heat treatment apparatus to be utilized as a single plate for heating and cooling, and especially in the cricket conditions simulator, the present status including the plurality of deficiencies of the heat treatment apparatus, suggest, despite its merits of application in the semiconductor industry, it has no utility in the cricket conditions simulator, retrofitting existing cricket pitches or in the construction of new cricket pitches.

### GENERAL

Increasingly, cricket is gaining ready acceptance into non Commonwealth Countries not only because of increased migration of formerly British subjects to those countries, but because of increased profit margins attained by the sponsoring bodies, as well as spectator demand for high performance from their supporting cricket teams in competition at local, regional and international levels. Considerable changes in atmospheric conditions attributable to diverse theories associated with global warming, have resulted in increased random climate changes such as sudden high turbulent wind gusts, unusual increases or reduction in precipitation and temperatures with simultaneous increase or decrease in relative humidity, over cricket pitches, poses considerable difficulties to cricketers, irrespective of if it is during batting, fielding or bowling.

The cricket pitch in nearly all Countries in which it is played is constructed of varying combinations of different soil materials such as sand, clay, loam, silt and muck, pulverized dust from rice hulls or sugar cane baggase residue from burnt sugar cane residues after the juice has been extracted, and other organic materials such as chopped grass, jute and wood chips. Based upon the perception of the type of batting and bowling impermeable cricket pitch the curators of the cricket pitches wish to create, a high compression loading by heavy cylinder compaction regimentation is introduced to remove voids from between and within each constituent, with the ultimate and latent intent and effect to construct a cricket pitch with competitive advantage to the team of preference.

Most cricket pitches associated with many venues throughout the cricketing community are very unpredictable, and this may be attributed to total lack of rigorous scientific understanding of the medium created for the cricket pitch, and therefore the need exist for the invention of a cricket conditions simulator to create an environment whereby data on real time cricket pitch conditions can be quickly conveyed to the batsman and or bowler during practice and or during live cricket competition for appropriate corrective actions, considering different physical and social environment and operative pitch conditions.

Additionally, it takes considerable years for cricketers to be exposed to different cricket pitches with corresponding playing environment, and most times only those at test level achieve such experience. Cricketers with considerable potential and especially in the less developed countries in which cricket is played, are devoid of such exposure, and most times because of not only the deficiency as well as paucity in facilities to simulate a plurality of cricket pitch and environmental conditions, but do not have the financial capability to travel to those countries in which cricket is played to realize that experience.

A cricket pitch heating assembly is invented and described herein as a heating plate or a single plate, with no deviation from the spirit of the invention, in direct contact with the underside of the cricket pitch, and may also be considered a thin layer flat plate, to facilitate an efficient and uniform transfer of heat to the subsurface medium of the cricket pitch by conduction. This considerable quantity of heat propels bound and free moisture into vapor state within the complex. It is the vapor under pressure which flows towards the surface of the cricket pitch, as a direct function of vapor pressure differential with corresponding temperature gradient.

Hot or chilled water is circulated continuously through the plurality of pipe system of the heating plate to maintain the plurality of desired temperature and moisture content of the cricket pitch. Pumps are utilized to circulate the water to and from the said heating plate thereby providing the means of maintaining the water under a plurality of positive pressure.

The supply of hot or chilled water to the cricket pitch is dependent on the plurality of thermodynamics of the air above the cricket pitch as well as the plurality of temperature and moisture content (vapor pressure) of the cricket pitch.

Cricket Ball and Cricket Pitch Relationships

Soils

The formulated quantities of soil, in conjunction with other organic and inorganic materials are structurally a complex medium to include textural constants associated with cohesiveness, expansion, elasticity and friction. As regards capillarity, Atterberg factors such as liquid and shrinkage limits in addition to plasticity index are applicable. Moisture equivalent such as centrifuge and field coupled with volume changes are inherent classified soil engineering properties to affect the Theological properties such as operative warping normal, diagonal and longitudinal tensile and compressive stresses, shrinkage, elasticity and porosity of the cricket pitch relative to cricket ball aerodynamic interactions, during practice or competition.

The soils in most cricket pitches are not placed in discrete layers, but are lumped together for uniformity so that lens are not formed. Due to high surface areas of clay, silt and pulverized organic materials, very strong affinity for binding hydrocarbons chains associated with organic materials to the surface of the clay and silt, usually exist. This heterogeneous rather than homogenous nature of the cricket pitch would be more hydraulically conducive to heat penetration and moisture transfer.

The rate of cricket pitch plurality of deterioration is dependent on many factors, and in most instances decides the outcome of game, if understood as an asset component to be strategically applied. The invented cricket conditions simulator has the plurality of capacities to provide a plurality of estimates of cricket pitch deterioration, as it relates to optimum and sustained compaction density of the cricket pitch relative to simultaneous and plurality of moisture content, temperature, and during practice vibrations; a plurality of additional estimates of cricket pitch compaction may be observed by use of penetrometer.

Miscellaneous

Air is regarded as a medium of continuous quantities, therefore thermodynamics attributes to include, pressure, density, temperature, kinetic energy and velocity are assumed to vary relative to their individual coordinates, if the discrete molecular nature of it, as a gas, is considered non existent. Aerodynamics of the cricket ball may be viewed as the study of the relationship among thrust, velocity, total drag, alignment, weight, gravity and lift as it moves through air prior to, at and after impact on the cricket pitch.

The cricket pitch is normally a very complex elastic medium with which to tinkle, because the manipulation of moisture content and temperature in most mediums capable of sorption and or desorption requires an understanding of the moisture ratio variations relative to the drying characteristics, as well as the drying time of the said medium. Additionally, the thermodynamic properties of the said medium relative to Gibbs Free Energy, and Entropy would vary with moisture content and temperature, in a variety of ways which could be progressive or linear, but, the Heats of Vaporization takes on exponential behavior over moisture content variations. Moisture content and temperature also affect the heat transfer constants within the said medium and should not be overlooked, since both moisture content and temperature affect the thermal conductivity, specific heat, thermal diffusivity and density of the said medium. There are instances in which the interaction between moisture content and temperature could add another twist to the general understanding of the said medium.

It is also understood the air completely surrounding the cricket ball in flight would have a tendency to adhere to the cricket ball, and as the ball move through the air, the air also would set up a boundary layer at the surface of the cricket ball with velocity of the air varying from zero at the surface of the cricket ball to the bulk velocity of the air away from the cricket ball. But, because the cricket ball has protruding stitches, the boundary layer around the cricket ball would be destroyed because of any spin on the cricket ball and turbulence induced by the stitches. Based upon these two said major factors, the region behind the cricket ball would experience unsteady and not steam or laminar flow.

To add yet another twist, volumetric convective heat transfer coefficient is introduced to add color to the understanding of the said medium, since it is identifiable variable both at the respective interfaces between the surface of the cricket pitch and the air, as well as that between the air and surface of the cricket ball. The said cricket ball also has thermal constants as the cricket pitch, but, given operative wind velocity and direction, may be present during the bowler's delivery of the cricket ball to the batsman at a premeditated delivery angle. Said wind can operatively exert a multi-directional wind pressure in a longitudinal, diagonal and transverse manner across the said cricket pitch, with diverse consequences of the cricket ball in delivery mode.

Since the cricket pitch is not a rigid surface, but, an elastic medium absorbing the shock from the cricket ball, and this introduces yet another group of complexities considering rehological, geotechnical, thermal and thermodynamic properties to be added to the relationship of the cricket ball relative to the cricket pitch. With respect to the thrust in the cricket ball, it is resolved into normal and tangential components, as the horizontal component essentially attempts to excavate a very small region of the cricket pitch or twist or shear a section out of the cricket pitch corresponding to the area of that section of the cricket ball which impacts the said cricket pitch. Such a twisting action would generate shear stress and shear rate deformation which is integrally related to the viscosity of the cricket pitch. The normal component of the thrust from the cricket ball is referred to as warping compressive force of the cricket ball, as it attempts to push the cricket ball as many millimeters into the cricket pitch, and this action introduces elastic resistance to bending of that region influenced by the impact of the cricket ball including the geometrical and mechanical constraints respectively associated with depth of deformation and resistance. Said region of influence actually extends beyond the actual area in contact with the said cricket ball, of which specific analysis is required to determine its effect on the degree of compaction of the cricket pitch.

Both the warping compressive and tangential stresses imposed on the cricket pitch as a result of said cricket ball impact could be affected by the surface roughness, modulus of elasticity, viscosity, porosity; geotechnical attributes such as moisture content, plasticity index, liquid limit, plastic limit, shrinkage ratio, expansion as volume change; and the said thermal constants and thermodynamic properties confounded within the compaction of the cricket pitch.

The net mechanical force of the surface of the cricket ball is:
∫Pnda.
where:
P=Pressure (Lbfin²)
n=Normal direction to surface of the cricket ball
a=Surface area (in²)

It must be emphasized once the cricket ball impacts the ground a percentage of the normal component of the kinetic energy in the cricket ball is converted to warping compressive stress thereby inducing vertical deformation at that specific point and the immediate region surrounding the impact on the cricket pitch.

There is a change in momentum in the cricket ball attributable to impact on the cricket pitch and this will also generate an imposed force similar to that of a spring, with the usual consequence of change in alignment and velocity, hence lift and drag of the cricket ball.

The bowler adds another variable to the cricket ball at the delivery point. This variable is in the form of a sub group message which is a component of several messages the bowler imparts into the delivery. This is the specialized and often most difficult to impart rudder effect variable that propels the cricket ball into a specific direction prior to, and after impact. Only very few bowlers have the capacity to execute this phenomenon if the atmospheric conditions are conducive.

Given the multiplicity of variables identified thus far, the degree of lift and alignment in the cricket ball after impact on the cricket pitch could be estimated. One approach is to adapt a procedure that could provide a rational basis for further evaluation, considering the dimensions of variables identified in the above, and mechanism that groups and reduces the variables to dimensionless groups.

Dimension analysis is a methodology which provides an opportunity to identify pertinent quantities, considering the bowler run up velocity to the wicket, the delivery of the cricket ball, the impact of the cricket ball on the cricket pitch, and the attack velocity, thrust and alignment of the cricket ball to the batsman as a single physical system, in which the pertinent quantities with dimensions can be identified, known relationships grouped, and the basis for new relationships established and or formulated, by further considering aerodynamic, geometric, kinematic, geotechnical, mechanical, and thermal units and relationships.

Based upon dimensional analysis, the developed general expression to be utilized to describe the thrust in cricket ball delivery, before, during and after impact to cricket pitch, by considering each of the below identified variables in singular or combination of quantities in dimensionless format is as follows:
TH_{B}=∫(V_{bc},V_{win},VₐₚD_{RBC},D_{RAC}G,Tₐ,T_{B},T_{P},R_{B},Tw,DH_{B},ρ_{Ba},t_{B},h_{Ba},Ht_{B},Cₚₐ,fᵥₐₚ,k_{B},σ_{B},W_{VAP},ρₐ,ρ_{B},DL_{B},C_{pB},RHₐ,H_{P},σₐ,E_{P},Ψ_{P},MC,PR_{P},GF_{P},N_{P},k_{P},σ_{P},ρ_{P},Ht_{P},h_{P},LL_{P},PL_{P},PI_{P},MI_{P},φ_{P},I_{AP},μ_{P})
where:
TH_{B}=Thrust in Ball (Lbf/Ft²)
V_{bc}=Velocity in Ball before contact (Ft/Sec)
V_{win}=Velocity in Wind (Ft/Sec)
Vₐₚ=Velocity in Ball after contact (Ft/Sec)
D_{RBC}=Drag in Ball before contact (Lbf/Ft²)
D_{RAC}=Drag in Ball after contact (Lbf/Ft²)
G ρₐ=Gravity (Ft/sec²)
Tₐ=Temperature of Air (° F.)
T_{B}=Temperature of Ball (° F.)
T_{P}=Temperature of Cricket pitch (° F.)
R_{B}=Surface Roughness of Ball (Ft/Ft)
Tw=Temperature of Water (° F.)
DH_{B}=Height of Ball at Delivery (Ft)
ρ_{Ba}=Density of Ball in Air (Lbm/Ft³)
t_{B}=Ball Travel Time (Sec)
h_{Ba}=Convective Heat Transfer Coefficient of Cricket Ball to Air (Btu/Hr Ft²° F.)
Ht_{B}=Heat transfer rate of Ball (Btu/HR ° F.)
Cₚₐ=Specific Heat of Air (Btu/Lbm ° F.)
fᵥₐₚ=Water Vapor Transfer rate at Water Air interface (Lbm/Hr Lbf))
k_{B}=Thermal Conductivity of Ball (Btu/Hr Ft²° F.)
σ_{B}=Thermal Diffusivity of Ball (Ft²/Hr
W_{VAP}=Evaporation rate of Cricket Pitch (Lbm/Hr)
ρₐ=Density of Air (Lbm/Ft³)
ρ_{B}=Density of Ball (Lbm/Ft³)
DL_{B}=Delivery Length (Ft)
C_{pB}=Specific Heat of Cricket Pitch (Btu/Lbm ° F.)
RHₐ=Relative Humidity of Air (%)
H_{P}=Thickness of Cricket Pitch (Ft)
ρₐ=Density of Air (Lbm/Ft³)
E_{P}=Modulus of Elasticity of Cricket Pitch (Lbf/Ft²)
Ψ_{P}=Deflection of Cricket Pitch (Ft)
MC=Moisture Content of Cricket Pitch (%)
PR_{P}=Poison Ratio
GF_{P}=Gibbs Free Energy (Btu/Lbm ° F.)
N_{P}=Newtons Constant (Lbf Sec²/Lbm ft)
k_{P}=Thermal Conductivity of Cricket Pitch (Btu/Hr Ft²° F.)
σ_{P}=Thermal Diffusivity of Cricket Pitch (Ft²/Hr)
ρ_{P}=Density of Cricket Pitch (Lbm/Ft³)
Ht_{P}=(Ft)
h_{P}=Convective Heat Transfer Coefficient of Cricket Pitch to Air (Btu/Hr Ft²° F.)
LL_{P}=Liquid Limit of Cricket Pitch
PL_{P}=Plastic Limit of Cricket Pitch
PI_{P}=Plasticity Index
MI_{P}=Moment of Inertia (In⁴)
I_{AP}=Section Modulus of Section of Cricket Pitch (Ft³)
μ_{P}=Viscosity of Cricket Pitch (Lbf sec/ft²)
φ_{P}=Angle of friction of Cricket Ball to Cricket Pitch

### SUMMARY OF DISCLOSURES

Several indoor cricket training facilities exist in Australia, New Zealand, England, South Africa, India, Pakistan and in the West Indies. Except for those in the West Indies all others are equipped with a plurality of indoor climate control to facilitate practice year around, considering the plurality of inclement outdoor weather conditions in late fall, winter and early spring. As regards the West Indies, the inclement weather is excessive rain.

Various cricket clubs and even government institutions in the above referenced countries, have created holistic improvement and development programs, in conjunction with variable rate technological advances in data collection on opponents psychological and performance profiles, body position relative to force and locomotion analysis, high illumination lighting systems, means for filming practice sessions for data analysis to generate recommendations for cricketers improvement, dormitories with cafeteria, gymmasium, coaches and other administrative staff offices, means for audiovisual reproduction, relaxation amenities, maintenance facilities, indoor cricket pitches with different surfaces, mechanized bowling equipment, and class room for theoretical and other instructions.

Each of the previously mentioned facilities with plurality of degrees of cricket improvements and enhancements' schemes and devices, has plurality of limitation especially in the area of simultaneous control of spectator distraction influence, air velocities, relative humidity, moisture content and temperature of the cricket pitch in opposing vertical directions during practice, as one of the means of simulating outdoor competition scenarios for cricketers, and such a circumstance, may be viewed as a limitation to the extent of the plurality of the quality of the training that could be achieved, therefore, the need for a cricket conditions simulator which has significant advantage over any previous device.

There continues to be a great need for facilities to improve the knowledge, performance and level of intense concentration, for cricketers in training during practice sessions, in order to acquire the degree of skill and professional fortitude, which requires extended periods as a learning curve, seminars, training camps, one to one correspondence instructions, behavior modification, nutritional instruction inputs, and game execution within different environments, to achieve top level performance competencies. The objective of this invention is to provide an environment wherein a holistic approach could be applied to cricket training facilities to reduce the time to achieve a level of understanding among cricket ball, cricket pitch relationships, considering a plurality of transient atmospheric conditions including a plurality of distraction mechanisms and cricket pitch properties and hence consequentially produces high performance at the least possible time and cost.

The introduction of the plurality of features offered by the cricket condition simulator as another practical and contributory instructional asset, to train cricketers in the acquisition of a plurality of superior competitive skills, in conjunction with other attributes in cricket is safe, satisfying and practical. Said simulator possesses a plurality of merits that is user friendly to cricketers, coaches and other cricket personnel. Another utility of the cricket conditions simulator is it reduces the size of the learning curve to produce a marketable professional cricketer with impeccable abilities, from which the cricket industry could benefit.

No previous art structurally recognized a single unit or device or apparatus, comprises of a plurality of mechanisms to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said below ground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic properties to include a plurality of interactions among Gibbs free energy, entropy, enthalpy, hysterisis, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitch relative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism to build mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art structurally recognized an equipment to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous art structurally recognized an equipment for installation under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art functionally described a single unit or device or apparatus, comprises of mechanism to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said below ground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic hysterisis properties to include a plurality of interactions among Gibbs free energy, entropy, enthalpy, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitch relative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism to build mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art functionally described an equipment to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous art functionally described an equipment for installation under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art previously suggested a single unit or device or apparatus, comprises of mechanism to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said below ground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic properties to include a plurality of interactions among Gibbs free energy, entropy, enthalpy, hysterisis, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitch relative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism to build mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art previously suggested an equipment to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous art previously suggested an equipment for installation under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art previously identified a single unit or device or apparatus, comprises of mechanism to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said below ground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic properties to include a plurality of interactions among Gibbs free energy, entropy, enthalpy, hysterisis, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitch relative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism tobuild mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art previously identified an equipment to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous art previously identified an equipment for installation under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art previously provided a single unit or device or apparatus, comprises of mechanism to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said belowground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic properties to include a plurality of interactions among Gibbs free energy, entropy, enthalpy, hysterisis, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitch relative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism to build mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art previously provided an equipment to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous art previously provided an equipment for installation under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art is operationally designed as a single unit or device or apparatus, comprises of mechanism to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said below ground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic properties to include a plurality of interactions among Gibbs free energy, entropy, enthalpy, hysterisis, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitchrelative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism to build mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art has operationally designed an equipment to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous art has operationally designed an equipment for installation under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art has been constructed as a single unit or device or apparatus, comprises of mechanism to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said below ground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic properties to include a plurality of interactions among Gibbs free energy, entropy, enthalpy, hysterisis, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitch relative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism to build mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art has constructed an equipment to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous art has constructed an equipment for installation under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art has the plurality of capabilities to simultaneously simulate or set as plurality of desirable thermodynamic, and aerodynamics conditions for cricket ball relative plurality of wind speeds, thermal constants and thermodynamics, geotechnical, rheological properties of cricket pitch relative to cricket ball, and plurality of spectator distraction levels as a single unit or device or apparatus, comprises of a plurality of mechanism to continuously, collectively, and simultaneously in an integrative manner, control a plurality of technical attributes within a building designed with special insulation for an indoor cricket facility, to include: a plurality of air thermodynamics; mechanisms to control a plurality of engineering properties such as rheological, mechanical, geotechnical, thermal, chemical and agronomic properties of bowling and or batting cricket pitch; mechanisms to control a plurality of operative acoustic and illumination of the playing environment; mechanisms to evaluate and control a plurality of batting, fielding and bowling techniques with instant or delayed instruction through replay a plurality of real time photographs relative to cricket pitch and environmental conditions; mechanisms to observe a plurality of practice sessions for leisure or to generate noise or to generate noise or for scientific data collection and analysis; mechanisms to provide for a plurality of operative visual distractions as spectator influence; mechanism to create a plurality of wind speeds and wind directions over the cricket pitch; mechanisms to convey any excess water from the cricket pitch and its contiguous environment; mechanism to simultaneously measure a plurality of wind speeds, temperature and relative humidity over the cricket pitch; mechanisms to distribute a plurality of prescribed quantity of water to cricket pitch; mechanisms to provide a plurality of prescribed quantity of water vapor to the atmosphere over cricket pitch, to alter the relative humidity over the cricket pitch in order to facilitate a plurality of moisture adsorption of the cricket pitch; mechanism to alter the a plurality of moisture contents of cricket pitch by adsorption and desorption of the cricket pitch complex; mechanism to observe the a plurality of pressures of the cricket ball on the plurality of impacts to the cricket pitch; mechanism to observe the plurality of moisture contents and temperatures of the cricket pitch on a continuous and instantaneous basis; mechanism to facilitate seating of a plurality of strain gages to observe a plurality of pressures of cricket ball on the plurality of impacts to the cricket pitch; mechanism of a plurality of access holes to facilitate the location of a plurality of strain gages, thermocouples and moisture probes on the cricket pitch heater assembly termed or identified as heating plate or single plate; means of controlling a plurality of heat loss from the said heating plate; mechanism to transfer heat from heating fluid identified as water, through the top and other surfaces of the heating plate, which in turn transports the said heat by conduction uniformly, vertically and longitudinally, to either elevate or reduce the temperature of the subsurface medium, as well as the top surface of the cricket pitch; mechanism for supporting the insulation on the under side and sides of the heating plate; mechanism for supporting the heating plate; mechanism for anchoring the heating plate structural support mechanism to a general foundation structure; general foundation mechanism to support the said heating plate structural support mechanism; a plurality of general below cricket pitch assembly access passageways to provide maintenance to all subsurface cricket pitch moisture content, temperature, pressure sensors and other structures with their associated appurtenances; means to facilitate a plurality of air distributions across and along the below the said ground passageways; mechanism to remove any water accumulated in the said below ground passageways by use of a plurality of gravity drains and sump pump in sump; mechanism to heat and chill water and control the respectively chilled or heated plurality of water flow rates to be supplied to the heating plate; mechanism to photographically record with a plurality of capabilities to produce a plurality of still or single or multiple, or continuous frames renditions to determine the formation of a plurality of cracks on or within the cricket pitch, as well as for a plurality of cricket ball velocity determinations, and for a plurality of further analysis, on instant or any other basis; mechanism to store and control the appropriate plurality of water surface elevations of heated or chilled supply or return water to or from the heating plate; mechanism to bundle the plurality of sensing conductors into one supporting conveyor; mechanism to access the said below ground plurality of passageways; mechanism to access the a plurality of water storage facilities to perform a plurality of maintenance operations; mechanism to transport heated or chilled water to or from the heating plate and a plurality of storage facilities with a plurality of built in flow rates control mechanisms; means of providing for the plurality of thermally insulating the entire building; mechanism to integrate a single algorithm to control a plurality of temperatures, moisture contents, relative humidity, a plurality of impacting pressures of cricket ball on cricket pitch; mechanism to simultaneously or singularly control a plurality of operative thermal constants to include the relationship among thermal conductivity, specific heat, thermal diffusivity and density, a plurality of thermodynamics of the indoor environment relative to the cricket pitch constructed of any combination singularly or collectively of a plurality of concrete, asphalt, matins, polymer subsurface soil reinforcing grid, post tensioned soil reinforcing system with a plurality of anchors at one end and a plurality of means of compressing soil at the other end, a plurality of soils, organics to include a plurality of agronomic vegetative materials of the botanical type, a plurality of inorganic and hybrids of the previous mentioned constituents thermodynamic properties to include a plurality of interactions among Gibbs free energy, entropy, enthalpy, hysterisis, and a plurality of thermal constants to include the relationship among thermal conductivity, specific heat, thermal diffusivity and density, control of a plurality of soil constituents classified as rheological textural, capillary, moisture equivalence, shrinkage ratio, volume change and other structural and mechanical degradation features of the cricket pitch relative to cricket ball aerodynamics plurality of impact vibrations and other manmade vibrations, to include a plurality of operative velocities, acceleration, time, total drag, static and dynamic friction, distance, bounce or lift, alignment, and coordinates before and after impact of the cricket ball, and also in relation to a plurality of operative batting, fielding and bowling positions; means of use of dimensional analysis methodology to relate a plurality of pertinent dynamic, geometric, kinematic, mechanical and thermal associations considering cricket ball and cricket interactions as a physical system; means of providing for a plurality of positive grades of the terrain from a plurality of edges of the cricket pitch; mechanism to produce a plurality of estimates of cricket pitch and weather constants attributed to a plurality of the thermodynamics and dynamics of the air, as cricket pitch properties and behavior, in addition to a plurality of cricket ball aerodynamics are observed simultaneously with a plurality of bowlers and batsmen operative plurality of playing contributions; mechanism to create a plurality of atmospheric and a plurality of cricket pitch conditions along with a plurality of environmental constraints to cricketer's performance, with capability of replication on as required basis; mechanism to be used as a cricket education development device, wherein a holistic approach could be applied to cricket training facilities in which a plurality of scientific data, considering a plurality of transient atmospheric conditions and a plurality of cricket pitch properties, are collected, while executing a multiplicity of techniques in batting, fielding and bowling during a plurality of practice sessions of the playing environment, then analyzed and reduced to a plurality of estimates of cricket pitch and a plurality of weather constants, which are explained to cricketers in a plurality of easy to digest formats, by coaches and a plurality of other counseling personnel prior to and during a plurality of practice sessions; mechanism to build mental fortitude that is a necessary requirement in order to bat and bowl under a plurality of environmental and a plurality of cricket pitch conditions for extended periods; mechanism to reduce the time to achieve a level of understanding among a plurality of cricket ball, cricket pitch relationships, considering a plurality of transient atmospheric conditions and a plurality of cricket pitch properties and hence facilitate high performance with level of intense concentration at the least possible time and cost; mechanism to provide a plurality of estimates of cricket pitch deterioration relative to a plurality of cricket pitch compaction density, moisture content, temperature and frequency and magnitude of induced vibration.

Additionally, in keeping with the spirit of this invention, no previous art has the plurality of capabilities to retrofit existing cricket pitches to cause to experience a plurality of desired levels of moisture content, temperature and compaction levels; said equipment comprises of a plurality of aluminum heating and cooling tubes: a plurality of flow control valves: water heater: chiller: pumps: a plurality of wind velocity, temperature and relative humidity sensors and moisture probes with respective plurality of recorders: and optional construction of reinforced concrete beams or reinforced concrete slab under the plurality of curved sections of the said tubes.

Further, in keeping with the spirit of this invention, no previous has the plurality of capabilities to be installed under new cricket pitches to cause to experience a plurality of desired levels of moisture content, temperature and compaction levels; said equipment comprises of a plurality of aluminum heating and cooling tubes: a plurality of flow control valves: water heater: chiller: a plurality of pumps: a plurality of micro-irrigation system (not shown); a plurality of wind velocity, temperature and relative humidity sensors and moisture probes with respective plurality of recorders: optional construction of a plurality of reinforced concrete beams or reinforced slab and or a plurality of underground means for access and maintenance as in claim 1.

No previous art has modified the said invention to include aluminum plate 18 in order to retrofit existing cricket pitches to experience a plurality of desired levels of moisture content, temperature and compaction levels.

No previous art has adapted the said invention to include aluminum plate 18 in order to retrofit existing cricket pitches to experience a plurality of desired levels of moisture content, temperature and compaction levels.

The cricket conditions simulator offers cricketers, coaches and governing bodies of cricket, another scientific tool for use in the cricket industry. The cricket conditions simulator is safe to use with no moving parts.

The cricket conditions simulator is satisfying to cricketers, coaches and administrators.

The cricket conditions simulator assist to build mental fortitude that is a necessary requirement in order to bat and bowl under a plurality of environmental and a plurality of cricket pitch conditions for extended periods.

The cricket conditions simulator is easy to construct.

The cricket conditions simulator has a plurality of capabilities to provide a plurality of estimates of cricket pitch deterioration relative to cricket pitch plurality of compaction densities, moisture content, temperature and frequency and magnitude of a plurality of induced vibrations.

The cricket conditions simulator is equipped with a plurality of capabilities, to provide for specialized quality assured and specific tailor to order training, considering a plurality of environmental and a plurality of cricket pitch conditions.

The cricket conditions simulator is equipped with a plurality of capabilities, to enhance the integration of a plurality of existing programs offered by other cricket academies, as well as to offer a plurality of programs not offered by the said facilities.

The cricket conditions simulator is equipped with a plurality of capabilities, to provide an opportunity for a plurality of retired first class and test cricketers to market and impart their skills in a plurality of means in a structured environment.

The cricket conditions simulator is equipped with a plurality of capabilities, to execute intense crisis training regimentation for a plurality of general and also a plurality of specific improvements for a plurality of cricketers, cricket clubs and governing administrations', that may consider the said regimentation, a requirement for improving the performance of contracted personnel.

The cricket conditions simulator is equipped with a plurality of capabilities, to provide the level of training for optimized performance, in order that a plurality of cricketers, cricket clubs and governing administration may benefit, so that there is no need to participate in costly intense crisis training regimentation programs.

Cricket conditions simulator is an educational device that lays the foundation to expand the cricket industry.

### BRIEF DESCRIPTION OF THE DRAWINGS

FIG. 1 shows a plan view of the indoor climate simulator with a plan view of the invented cricket condition simulator pitch.

FIG. 2 shows a transverse cross-section view of the indoor climate simulator with a transverse cross-section view of the invented cricket condition simulator pitch.

FIG. 3 shows a detailed plan view of the invented cricket condition simulator pitch.

FIG. 4 shows a detailed transverse cross-section view of the invented cricket condition simulator pitch.

FIG. 5 shows a detailed longitudinal cross-section view of the invented cricket condition simulator pitch.

FIG. 6 shows a detailed longitudinal cross-section view of the pivoted spray boom of the invented cricket condition simulator pitch.

FIG. 7 shows spray boom manifold, gate valve, flexible coupling, nipples, spray nozzles along with vertical length adjustment device.

FIG. 8 shows spray boom modification central bracket.

FIG. 9 shows spray boom manifold and end bracket.

FIG. 10 shows front, side and plan views of pneumatic distraction device.

FIG. 11 shows insulation cover support bracket.

FIG. 12 shows retrofit heating and cooling equipment for existing cricket pitch or for new cricket pitches.

FIG. 13 shows a cross section view of thermocouple, moisture probe and strain gage in aluminum heater plate.

FIG. 14 shows a plan section view of thermocouple, moisture probe and strain gage in aluminum heater plate.

### DETAILED DESCRIPTION OF THE EMBODIMENTS/INVENTION

The description presented in the above embodiments are non restrictive, should be interpreted as illustrative, with no intent to exclude equivalent features, terms and expressions.

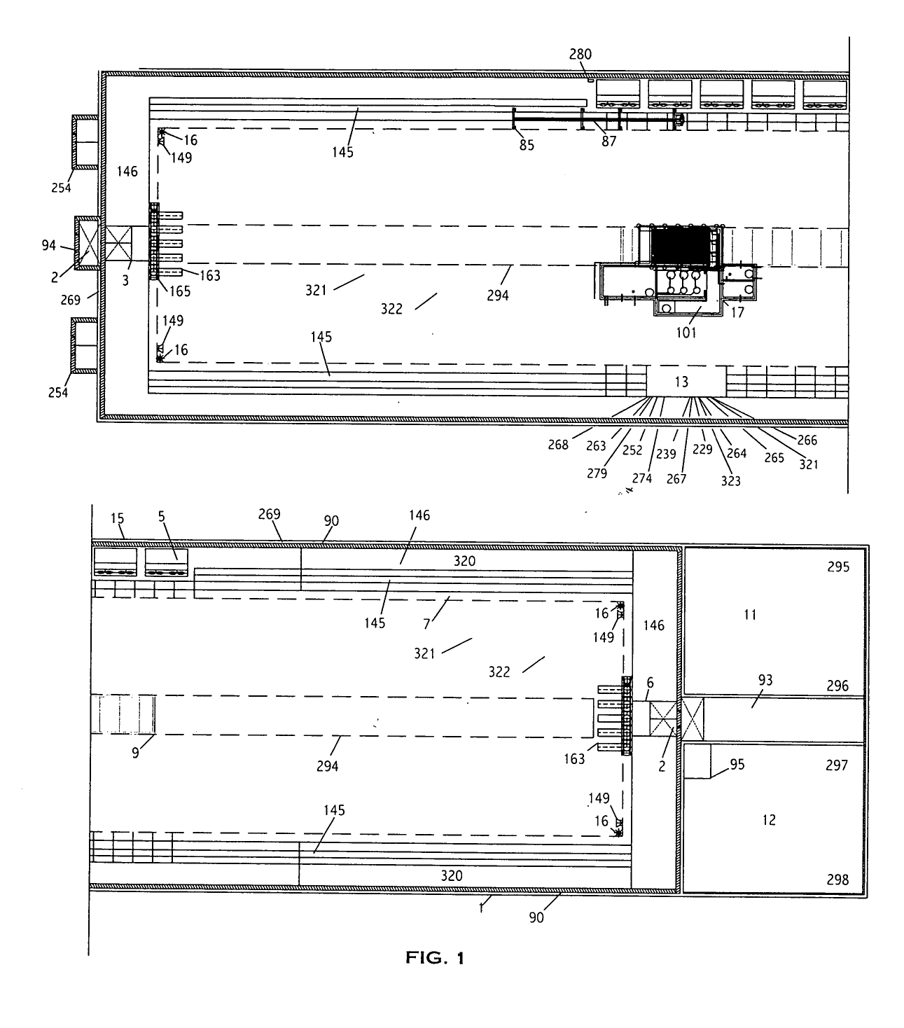

The invented cricket condition simulator consists of two main parts, which comprises a building structure 1 designed for a plurality of types and thicknesses of thermal resistance insulation and a further plurality of other features, and referred to as an indoor facility 1 or receptacle 1, with means to reproduce a plurality of outdoor weather conditions and a plurality of cricket playing conditions; and a plurality of cricket pitch 9 with a plurality of operatively elements positioned within the said cricket pitch 9, which is enclosed within a plurality of appurtenant structure means 17 as shown in FIG. 1, to respond to a plurality of specific simulated outdoor climatic changes, in addition to said cricket pitch 9 provided with a plurality of cricket pitch conditions, then exposed to a plurality of simulated outdoor climatic conditions.

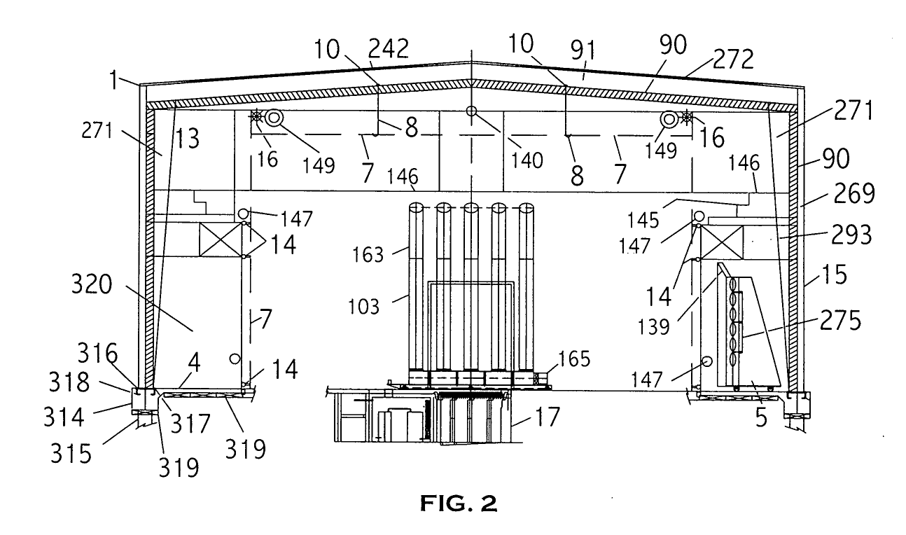

FIGS. 1 and 2 respectively show plan and cross section views of the said building structure 1, as a preferable rectangular shaped receptacle 1, comprises a plurality of structural features and within which a plurality of integral and necessary mechanisms are geometrically positioned to include vertical side walls 15, constructed of a combination of concrete blocks 269 and a plurality of tapered structural steel columns 271, to support the plurality of roof trusses 91 also constructed of structural steel; said roof trusses 91 support built up roof deck 242 of standing seam roof system 272 with a plurality of rigid and flexible high thermal resistance Styrofoam insulation 90; said steel columns 271 are welded to a plurality of structural steel base plates 317 which are rigidly connected to a plurality of reinforced concrete foundation grade beam 314 by a plurality of anchor bolts 318 means and hexagonal nuts and washers 316; said grade beam 314 is integrally supported by a plurality of reinforced concrete piers, should geotechnical engineering tests performed by state registered and qualified geotechnical engineer determined the soils upon which the said facility 1 is to be constructed is very expansive, and soil bearing allowable is low compared to the weight of the said facility 1, followed by a plurality of recommendations to include a plurality of reinforced concrete piers 315 and a plurality of void cartons 319 under said grade beam 314 and reinforced concrete slab 4; a plurality of other interior reinforced concrete beams, void cartons and reinforced concrete slab means are an integral part of the said facility 1 and are not shown.

It is contemplated that other than concrete blocks 269, the plurality of vertical side walls 15 may comprise a plurality of cast in place; a plurality of tilt up reinforced concrete walls; a plurality of earth fired bricks; a plurality of metal siding; a plurality of metal siding with interior reinforced concrete tie beam; a plurality of metal siding with rigid or flexible insulation; a plurality of side wall block masonry with reinforced concrete tie beam and no veneer brick; a plurality of side wall block masonry with no reinforced concrete tie beam and no veneer brick; a plurality for any combination of side wall block masonry, reinforced concrete tie beam, metal siding, veneer brick, insulated metal studs, air space, plywood, sheet rock, wood and cavity wall; and a plurality of any combination of partial side wall block masonry, reinforced concrete tie beam, metal siding, veneer brick, insulated metal studs air space, plywood, sheet rock, wood, cavity wall, and the like. It is further contemplated that other than Styrofoam thermal resistant insulation, a plurality of any combination or single use of rock-wool, fiber glass and the like, may be considered for thermal resistance insulation 90.

No cable bracing is utilized for wind load bracing for said structure 1, however, it is contemplated longitudinal and transverse bracing for the plurality of the said roof trusses 91, may be so designed for one sided, or off set, or wind posts or portal frame or fixed base end walls and the like to conform to wind uplift rating class 90 specification of Underwriters Laboratories.

The said roof deck 242 with a plurality of appurtenances identified herein is so positioned, to allow for expansion and contraction of structural members. The external finish of said building 1 is accomplished, by the application of a fluropolymer based finished coating, with the plurality of capabilities associated with high resistance to undulation, fading and chalking.

It is further contemplated that the said building structure 1 may be equipped with a plurality of structural water tightness mechanisms for integrity; aluminum faced thermal resistance insulation board over which a plurality of metal liners may be placed to improve the aesthetically appealing appearance of the underside of the roof or inside walls exposed to the public; a plurality of any combination of parapets, gutters, fascia with or with no overhang; a plurality of skylights; a plurality of vapor barriers may be utilized to prevent condensation of moisture within the body of the said insulation; the positioning of a plurality of spacer blocks within a plurality of sections of the said insulation, may be utilized to prevent compression of fibers within the insulation roof of the said, since compression may reduces the heat resistance quality of the said insulation, and hence the energy efficiency of the said building structure 1.

It is further contemplated that since the said foundation design depends upon local conditions, the plurality of the said base plates 317 may be recessed into the plurality of beams 314 and the plurality of columns 271 may be straight, instead of tapered.

It is further contemplated that a plurality of reinforced concrete columns, or a plurality of wood columns may be utilized instead of a plurality of the said structural steel columns 271.

Said facility 1 is also equipped with a plurality of refrigeration air condition units 254 with built in means of controlling the thermodynamics of the conditioned air, along with associated plurality of insulated ducts 293; spectator seating means 145 and walk-way aisle 146 constructed of wood, aluminum or concrete; a plurality of elevated platforms 3 and 6 for miscellaneous use and can be so positioned as required; specialized entrance door means 94 with a second chamber 2 equipped with seating accommodation for brief acclimatization stop to allow for a person's body temperature adjustments prior to entering or leaving the said facility 1; a plurality of permanent non tangling safety protection net 7, so positioned, to prevent the cricket ball from inflicting damage to people and equipment, and connected to hook means 8 which is constructed of stainless steel, and fastened to said roof truss 91 by a plurality of hexagonal nuts and washers 10; electrical power appurtenances, roof drainage, communication and plumbing means (not shown); front access entrance passageway 93; section 11 distributed over a plurality of levels to accommodate cafeteria, library, racquetball, and dormitories within floor areas 295 and 296; section 12 distributed over a plurality of levels to accommodate administration, gymnasium and dormitories within floor areas 297 and 298; elevator hoist 95; and a plurality of coaches lounges and class rooms 320. It is contemplated, to aid the cricketers' eye hand coordination, off site golf, lawn tennis, put-put golf and amenities such, heliport, maintenance facility, hotel, museum, subdivision infrastructure, transportation means, and education curricula, and Comprehensive Quality Policy Thinking (CQPT) as management system may be a component of the said facility 1.

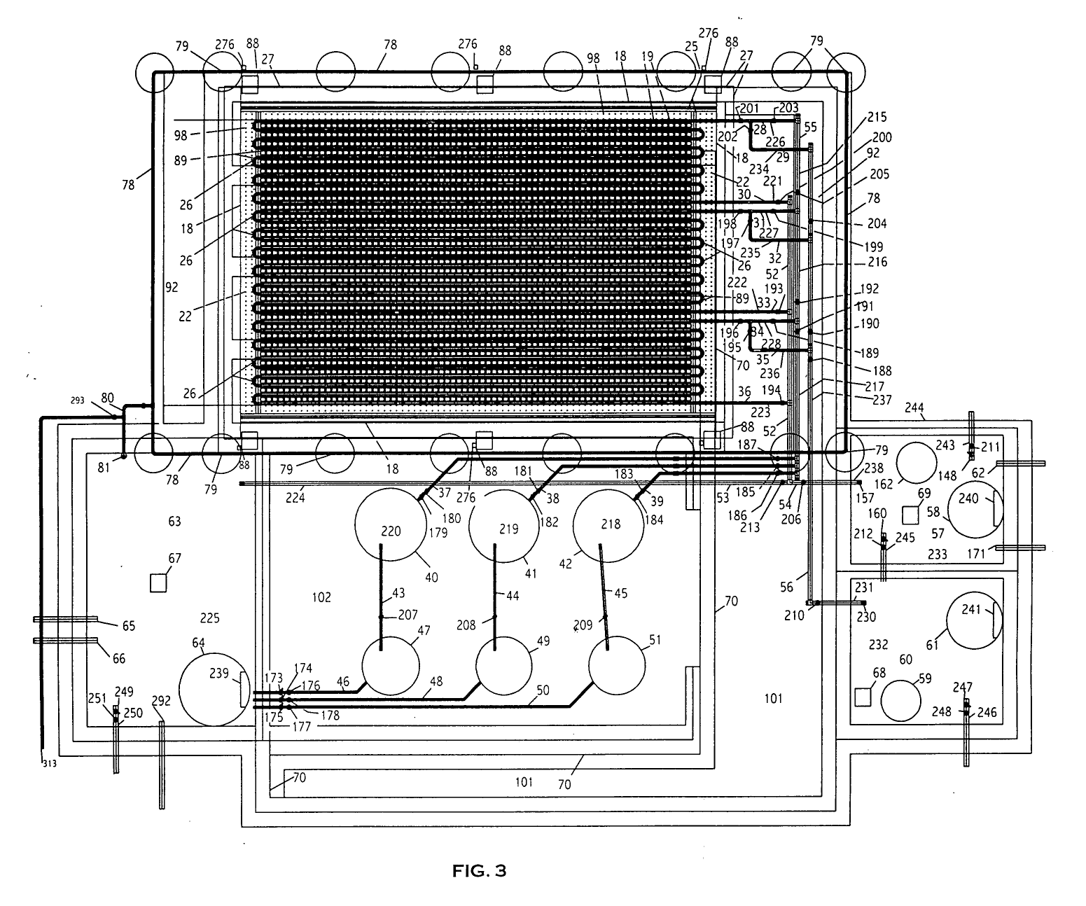

Referring to FIGS. 3, 4, 5, 13 and 14, the present invention also comprises a preferable rectangular cricket pitch heater assembly referred to as single metal plate 18 or aluminum plate 18 or single metal plate, to be integrally utilized by a plurality of appurtenant features enclosed within a plurality of structures 17, to include the construction of the said metal plate 18 from aluminum because of its high thermal properties and reduced cost compared to copper; a plurality of perforations 98 and 99 are drilled into aluminum plate 18 to respectively accommodate a plurality of thermocouple wires 22 and a plurality of strain gage support metal receptacles 19; a plurality of finned circular tubes 26 welded continuously to the said aluminum plate 18; a plurality of aluminum plates 25 and 24 positioned respectively on the perimeter as well as on the interior of the said aluminum plate 18, to add structural support therein; said aluminum plates 24 and 25 formed the legs support structure to the said aluminum plate 18 so that the said aluminum plates 18, 24 and 25 be connected as a single unit by a plurality of continuous weldments; heat transmission away from the undersurface of the said aluminum plate 18 as well as the plurality of appropriate surfaces of said aluminum plates 24 and 25 are prevented by utilizing 4″ thick layer of thermal resistance insulation 73 and positioned on the said underside of aluminum plate 18, as well as on the outside of aluminum plate 25.

Temperature measurements above the surface of the cricket pitch 100 are realized by utilizing a plurality of wet and dry bulbs temperature means 88. A plurality of other features associated with the said aluminum plate 18 of the invented cricket simulator comprised of micro irrigation system 79, 80 and 81; water storage tank 63 and plurality of appurtenances; chilled supply water storage tank 60 and appurtenances; chilled return water storage tank 57 and appurtenances; a plurality of concrete columns 95, 96 and 97; a plurality of thermocouples 22, strain gages 21, moisture content probes 23 and moisture content cable housing 70; pivoted spray boom 87; pitch surface material with vegetative or non vegetative material 77; a plurality of air circulation openings 71 and 72 in concrete columns 95; a plurality of access passageway 101; and water heater chamber 102.

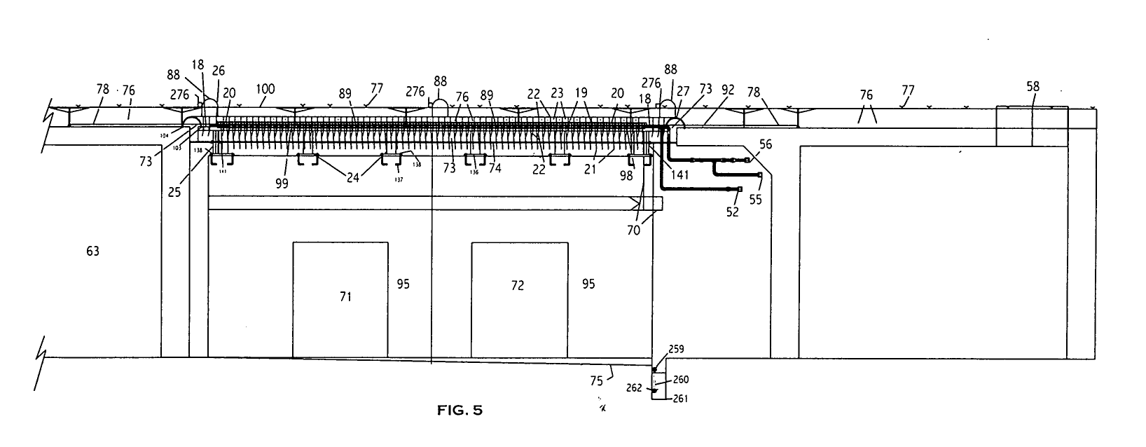

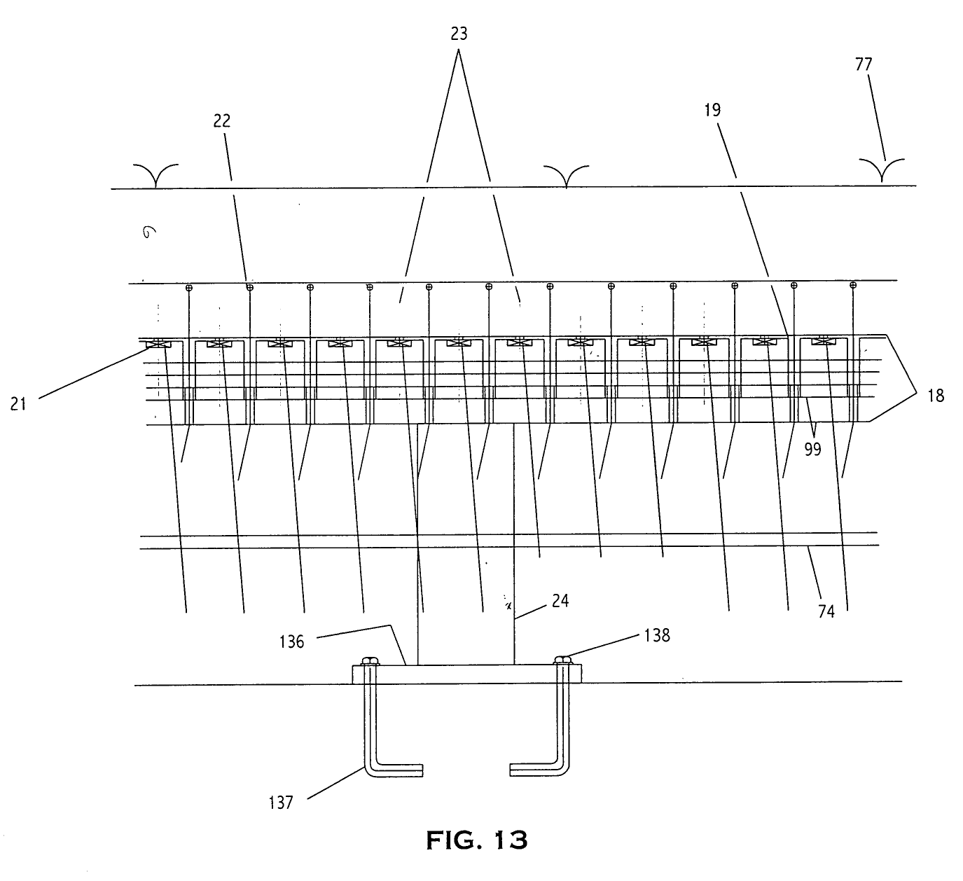

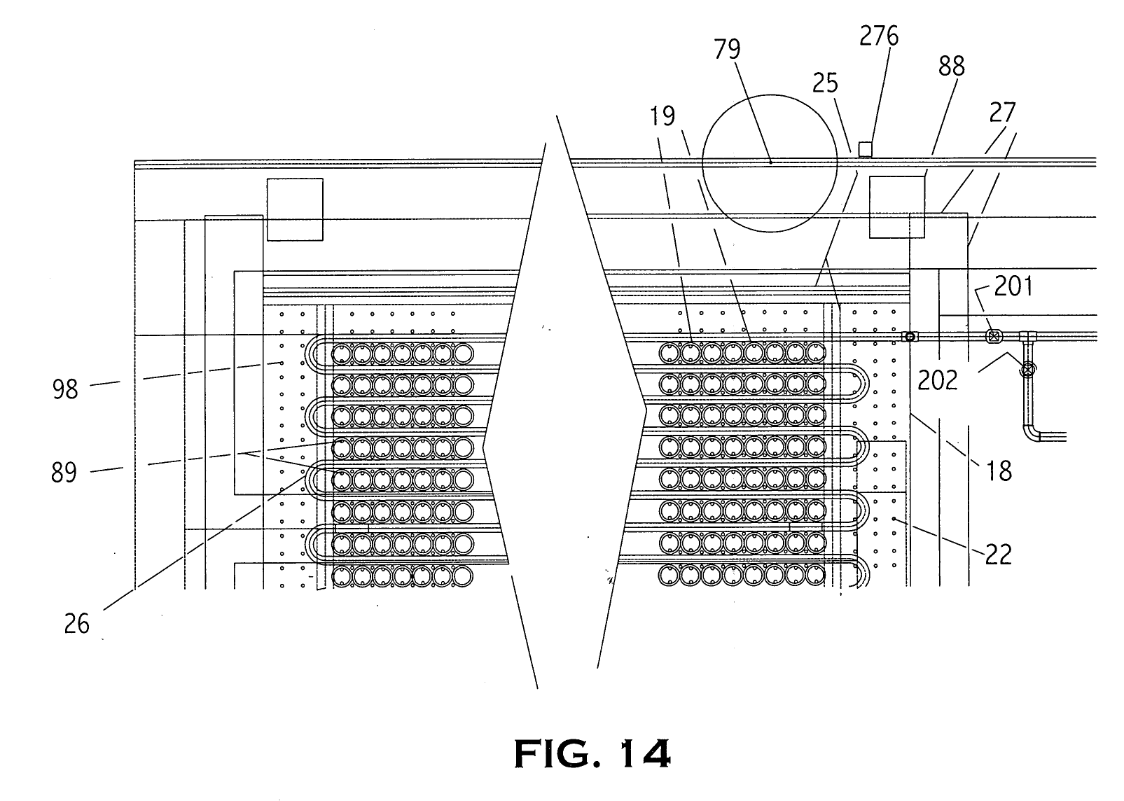

As shown on FIGS. 5 and 13, a plurality of strain gage ports 99 extend vertically from the bottom of the said aluminum plate 18 for 1½″ and diameter 1½″, thence continuing in the same vertical direction for another ½″ with a diameter of 2 1/16″. More specifically the said rectangular aluminum plate 18 is welded to and supported about its perimeter to a plurality of 2″ thick aluminum plates 25, as well as and about specific locations in parallel directions along the interior and away from the central longitudinal axis of the said aluminum plates 25, by a plurality of 1″ thick aluminum plates 24, to form a rigid structural frame support under the said rectangular aluminum plate 18. Said aluminum plates 24 are supported by a plurality of 8″ wide continuous reinforced concrete columns 95, where as, aluminum plates 25 are supported by a plurality of continuous reinforced concrete columns 95, 96 and 97. Both the perimeter 25 and interior 24 aluminum plates are welded to a plurality of 6×6″×⅝″ aluminum base plates 136, which are equipped with a plurality of ¾″ diameter holes to accommodate a plurality of ⅝″ diameter anchor bolts 137 and nuts 138. Said anchor bolts 137 are located in columns 95, 96 and 97. The said rectangular aluminum plate 18 is also equipped with 3/16″ diameter holes 98 to accommodate copper-constantan thermocouples 22. Said aluminum circular tube 26 of 1″ diameter×¼″ wall thickness is fixedly or integrally connected to a plurality of 1″ high×¼″ wall thickness and extended aluminum fins by a plurality of continuous weldments, to the said rectangular aluminum plate 18. The said aluminum tube 26 and aluminum plate 18, as a unit, provides for an even temperature distribution throughout the cricket pitch under consideration, thereby, facilitate for uniform conduction heat transfer through the said cricket pitch 9. A plurality of strain gages support metalreceptacle 19 comprises wall thickness of ¼″, height of 2′ and also constructed from aluminum. The said aluminum receptacle 19 is inverted in such a manner, to allow for the rim of the said aluminum receptacle 19 to be seated on the base of the 2 1/16″ diameter×½″ deep opening, located in the said rectangular aluminum plate 18. A plurality of a pair of ¼″ diameter holes 23 are drilled through the base of the plurality of the said aluminum receptacle 19 at 1⅞″ on centers, and opposite to each other, to accommodate a plurality of moisture content needle electrodes 89 as shown on FIG. 14.

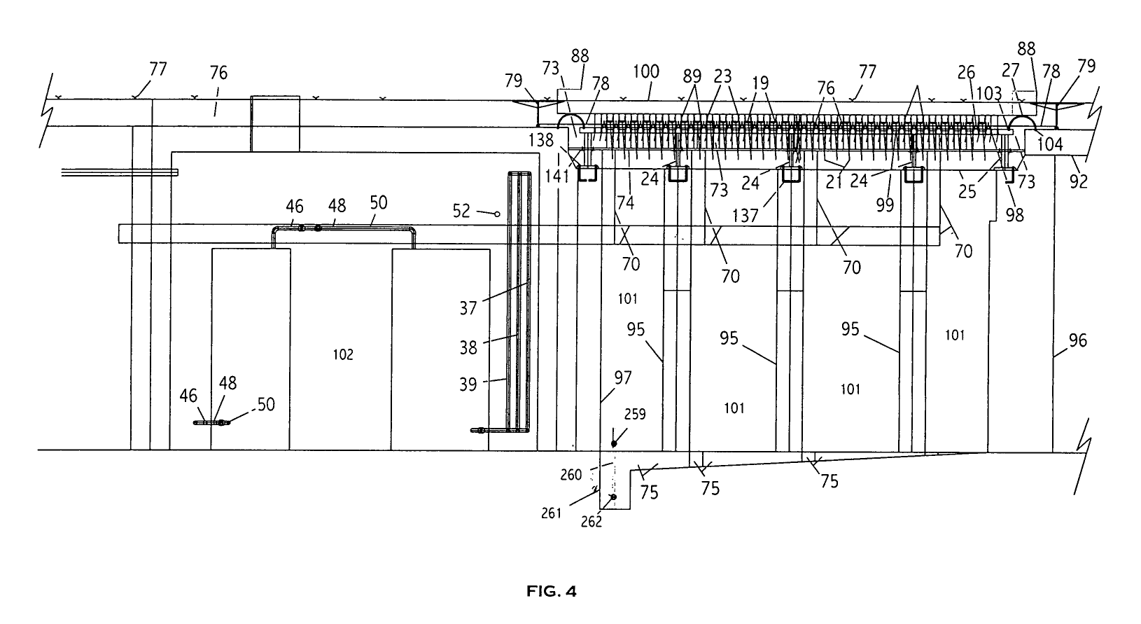

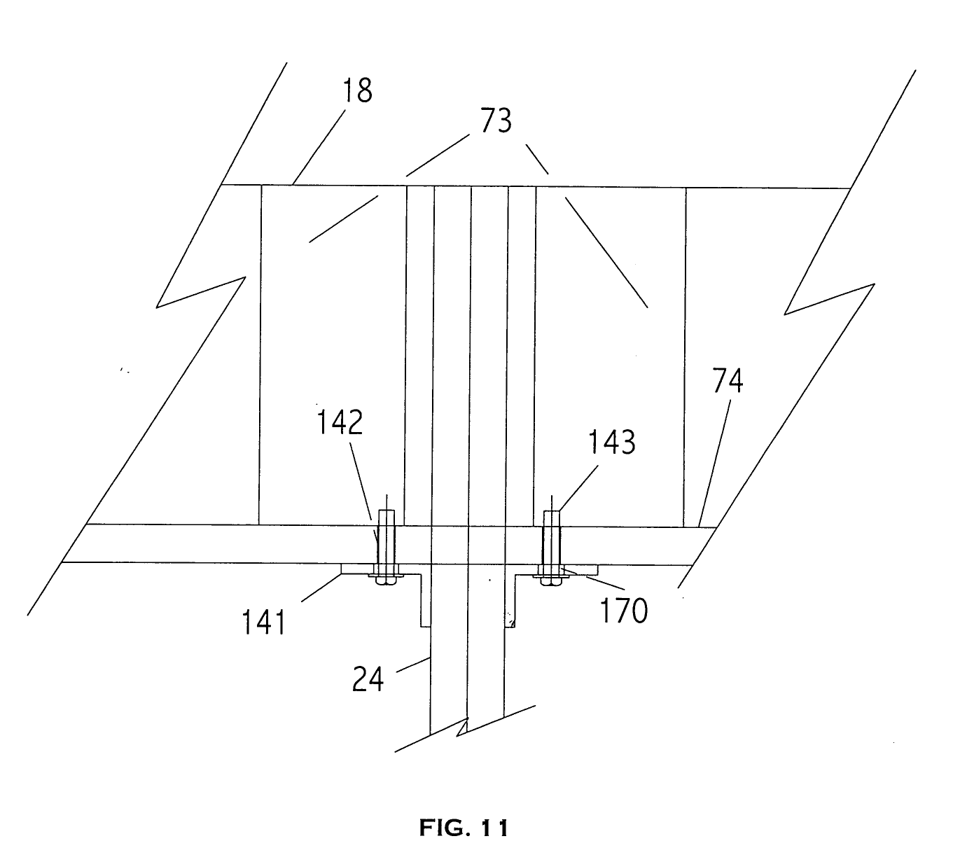

In addition to the outside of the said aluminum plate support 25, the underside as well as the sides of the said rectangular aluminum plate 18 are blanketed by a plurality of good quality flexible thermal resistant insulation 73. FIGS. 4, 5 and 13 show the said insulation positioned under the said rectangular aluminum plate 18 is supported by a plurality of ⅝″ thick treated plywood 74, which in turn is secured to a plurality of 4″ long×2″×3″×¼″ angled aluminum brackets 141, located on each side of respectively said interior aluminum plate 24, and said exterior aluminum plate 25 by a plurality of 1½″×⅜″ diameter aluminum screws 143. The plurality of the 3″ arm of the said aluminum bracket 141 is equipped with a plurality of 1½″×¾″ horizontal openings 170, with the plurality of the ¾″ orientation constructed in a parallel direction to the said 3″ arm, and the plurality of the said 1½″ orientation constructed parallel to the length of said bracket 141 as shown on FIG. 11. The said horizontal openings 170 are provided to facilitate a plurality of horizontal adjustments, needed when connecting said treated plywood 74 to the said aluminum bracket 141. A plurality of the said 2″ arms of the said aluminum brackets 141 are attached to the said aluminum plates 24 and 25 by a plurality of continuous weldments, although it is contemplated utilizing aluminum hexagonal nuts, bolts and washers, for fastening mechanism between said aluminum brackets 141 and said aluminum plates 24 and 25. The said treated plywood 74 is equipped with a plurality of high temperature resistant plastic inserts 142, to accommodate the plurality of said aluminum screws 143. A plurality of 6″ diameter×½″ semicircular high strength pressure plastic tube acts as a bridge 27, as the said bridge 27 traverses above the plurality of space between the said rectangular aluminum plate 18, and ancillary roof system 92, which is filled with the said layer of thermal resistant insulation 73. The plurality of open ends of the said semi-circular plastic bridge 27 fit securely and into a plurality of grooves 103 and 104, respectively positioned on the said rectangular aluminum plate 18 and said ancillary roof system 92.

The plurality of relative humidity of the air above the cricket pitch is determined by a plurality of arrangements 88 which utilizes a plurality of wet and dry bulb thermocouples in addition to a plurality of air-flows from a plurality of micro-fans, where as, further increases in relative humidity of the air above the cricket may be partially accomplished by the contribution of moisture from a plurality of pop-up micro-irrigation nozzles 79, which are connected to moisture adjustment irrigation system 78, 80 and 81. A plurality of additional relative humidity monitors 276 positioned 1″ from the outer surface of the said relative humidity means 88 to be utilized for emergency, should there be a malfunction of any of the plurality of the said relative humidity means 88.

A plurality of winds comprising a plurality of velocities and from a plurality of directions are created by utilizing a plurality of industrial fans 5, coupled into sets of four, to include mechanism 275 when in operative mode, provide for a plurality of elevations of wind velocity above ground. A plurality of additional wind directional changes is further enhanced by utilizing a plurality of wind deflectors 139 as shown in FIG. 2. A plurality of wind velocities sensing elements also positioned within a plurality of region allocated for the said relative humidity sensor 88, and manufactured by Kestrel as model 4000 Pocket Weather Tracker, are used to measure a plurality of wind speeds above the cricket pitch, as well as from those produced by said industrial fans 5. A key feature of the said tracker is its ability to provide a plurality of estimates of wind velocities continuously, and in real time. A plurality of mist atomizers 14 are strategically positioned at ground level as well as immediately above and below the aluminum ducts 293, to assist in elevating the plurality of relative humidity of the atmosphere away from the said cricket pitch. The supply of water to the said atomizers is from 1″ diameter PVC tubes connected to sump pump 81 discharge tubes 78 and 80 (not shown).

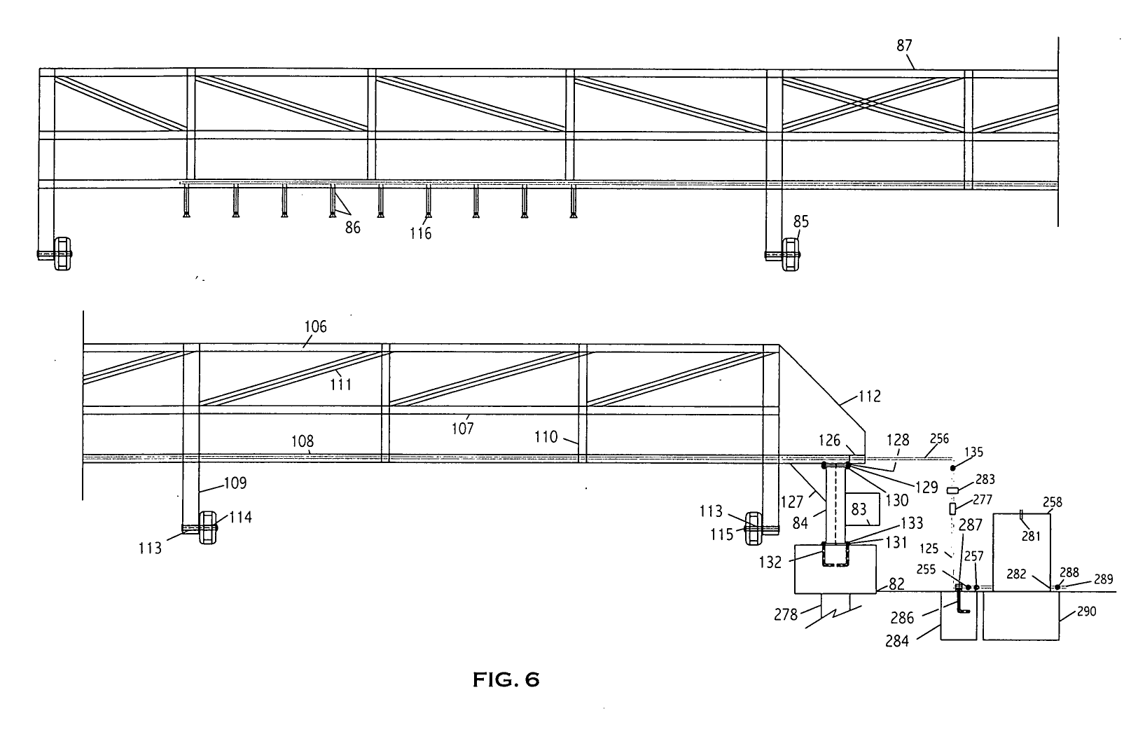

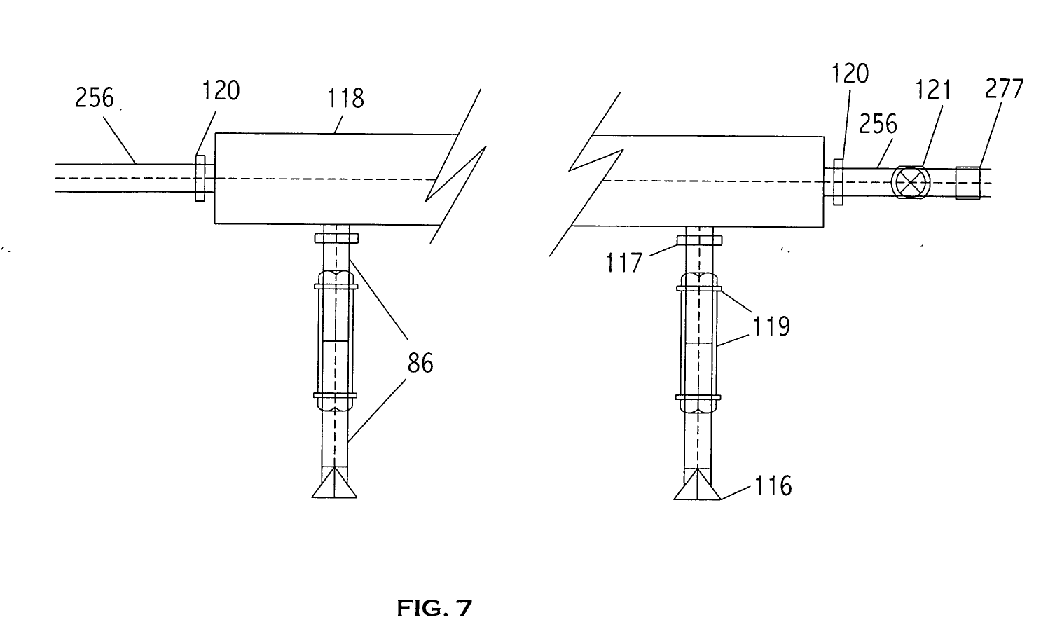

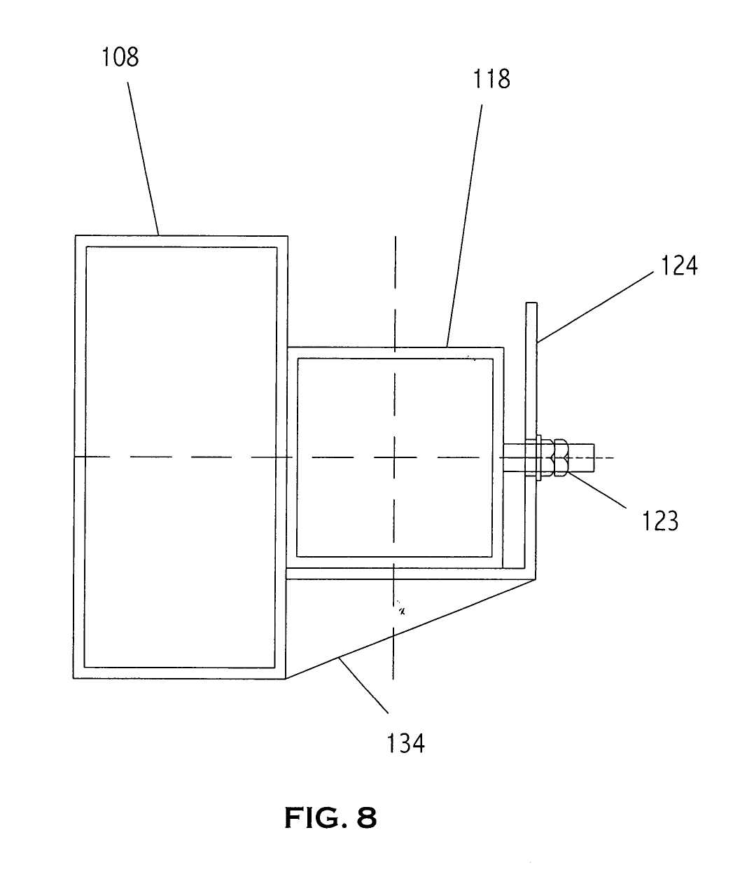

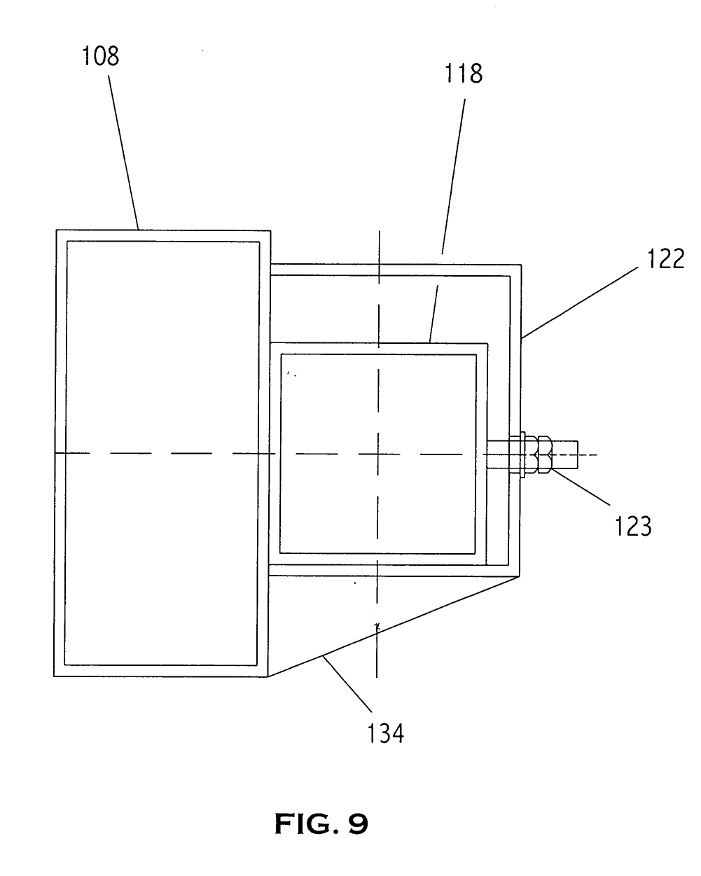

FIG. 6 shows spray boom 87 consists of a rigid frame which comprises a plurality of top chord 106, a plurality of central chord 107, and a plurality of bottom chord 108, plurality of diagonal bracing members 111, a plurality of additional structural support members 110 and 112 and a plurality of vertical wheel support member 109. A plurality of wheels 85 is constructed from synthetic rubber and also equipped with a plurality of grooved pressed fit bushing 113 attached to said vertical wheel support member 109 by a plurality of ¾″ diameter structural steel shaft 114, which is equipped with a plurality of integral keyed projection to be accommodated by the said grooved bearing pressed fit bushing 113. Said rubber wheel 85 is further secured to the said structural steel shaft 114 by utilizing a plurality of lock nut and washer 115. A plurality of fixed spray nozzles 116 are screwed to a plurality of aluminum pipes 86 which are also screwed into a plurality of brass nipples 117 which are welded to a plurality of 2½″×2½″ rectangular manifold 118 constructed from aluminum. The length of the said aluminum tube 86 may be increased or decreased by adjusting a plurality of aluminum lock nut coupling means 119 as shown in FIG. 7. A plurality of brass nipples 120 is welded to the said rectangular manifold 118 to accommodate 1″ diameter polyvinyl chloride (PVC) tube 256, which is equipped with a gate valve 121 positioned approximately 6″ from the said brass nipple 120, and another gate valve 135 located about 6″ from the pivot pipe 125, to control the flow of fluids to the said spray boom 87. Pivot pipe 125 is equipped a tubular swivel means 277 to facilitate lateral rotation The said rectangular manifold 118 is connected to the said lower chord 108, by utilizing a plurality of 3″×3″×⅜″ thick×2″ wide structural steel angle 124 at the center of the said manifold 118, as shown in FIG. 8; and also by utilizing a plurality of 3″×3″×⅜″ thick×2″ wide rectangular structural steel tube 122, at the ends of the said rectangular manifold 118 as shown in FIG. 9. Both 3″×3″×⅜″ thick×2″ wide structural steel angle 124 and 3″×3″×⅜″ thick×2″ wide rectangular structural steel tubing 122 which are welded to the said lower chord 108, are equipped at the center of the vertical arm with a lock screw arrangement 123, to further secure the said rectangular manifold 118 to lower chord 108. Both the said structural steel angles 122 and 124 are supported by brackets 134 constructed from structural steel. The structural members utilized in the construction of the spray boom 87, are constructed from structural steel, however, it was contemplated utilizing aluminum or less dense alloys for construction. A plurality of horizontal modifications to the said rectangular manifold 118, is accomplished by utilizing a plurality of adjustments, to lock screw arrangement 123 in conjunction to self accommodation to flexible coupling 277, located 6″ from gate valve 121. A plurality of additional structural supports 112, 126, 127 and said lower chord arrangement 108 are welded to a 12″×12″×¾″ structural steel plate 128, which is connected to another 12″×12″×34″ structural steel plate 129 by use of a plurality of ¾″ bolts 130 as shown in FIG. 6. Said structural steel plate 129 is welded to 8″ diameter×⅝″ thick structural steel tube shaft 84. The support end of the said 8″ diameter×⅝″ thick structural steel tube shaft 84, is welded to yet another 12″×12″×¾″ structural steel plate 278, and connected to a plurality of ¾′×18″ anchor bolts 132 by a plurality of ¾″ hexagonal bolts and nuts 133. The said ¾″×18″ anchor bolts 132 are set in reinforced concrete footing 82 which may be supported by a pier 131 based upon the soil bearing and expansive nature of the subsurface soil. Spray boom 87 power and control means 83 consist of a plurality and mechanisms to include drive motor, gear reducers, rotary union and switches which are integrally connected about the 8″ diameter×⅝″ thick structural steel shaft 84.

The fluid supply system associated with spray boom 87 consist of fluid storage tank 258, check valve 255, pump 257, pivot pipe 125 constructed of galvanized steel, swivel means 277, flexible coupling 283. The pivot pipe 125 is secured to the reinforced concrete foundation 284 by a plurality of 2″ “U” shaped wide strap constructed from ¼″ thick structural steel, a plurality of anchor bolts 286 and hexagonal nuts 287. Tank 258 is manufactured from PVC, and is equipped with a covered fill port 281, positioned at the top section of this said tank; port 282 is utilized for emptying the said tank 258, and is attached to a 1″ diameter PVC tube 289 attached to a gate valve 288. Said tank 258 is loosely seated on 6′×6′ reinforced concrete pad 290. Ground controller switch 280 is also available to control the plurality of movements of the said spray boom 87.

It is contemplated that an embodiment may increase the size of the said structural member 109, then attach a plurality of power and a plurality of control means to said structural member 109, considering upgrading the size of said shaft 113, to accommodate a plurality of motorized or a plurality of chain driven plurality of sizes of wheel 85. It is further contemplated that the said spray boom 87 could be operated manually and no need for motorized means. The fluid flow to the said spray boom 87, thence to the said cricket pitch, is controlled from central control room 13 by controller 279 or by electrical control 280.

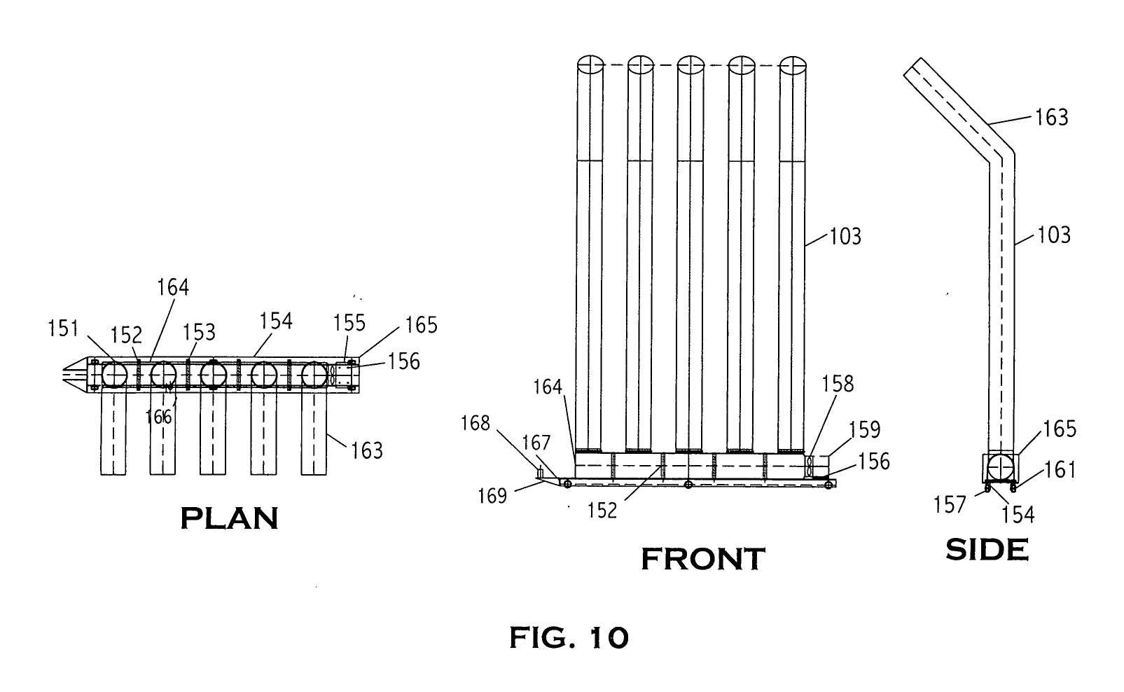

FIG. 10 shows the pneumatic distraction device 165 comprised a plurality of vertical, multicolored 6″ diameter flexible plastic tube 103, with a plurality of bent section 163.

Said plastic tube 103 is secured to the circular outward leg of a plurality Tee projection out of an 8″ diameter PVC tube 164, by a plurality of circular loop strap, constructed from 1″ wide No 24 gage galvanized sheet metal, with the plurality of two ends of the said sheet metal loop arranged in an overlapping manner, to facilitate a plurality of sleeves constructed from galvanized sheet metal, and a plurality of adjustable screws 151, to form a plurality of secured screw lock arrangement over the said Tee projection. Said 8″ PVC is secured to double 6″×6″ structural steel angle frame 154, by a combination of a plurality of 3″ wide and No 24 gage galvanized sheet metal straps 152, and a plurality of ½″ diameter hexagonal nuts, bolts, washers and screws 153.

Fan 158 is driven by motor 159 and is utilized to supply a plurality of pressurized air to said plastic tubes 103 and 163, to facilitate for side sway in air as a direct function of the volume and velocity of air through the said tubes 103 and 163. Said motor is secured to frame 154 by an arrangement of rectangular plate 155 and a plurality of ¾″ diameter hexagonal nuts, bolts, and washers 156. The plurality of 6″ diameter rubber wheels 157 are secured to the said frame 154 by a plurality of ¾″ diameter structural steel shaft along with a plurality of hexagonal nuts, bushing and washers 161. A hitching means consisting of 1″ diameter×4″ long structural steel pin 168 is welded to ½″ thick structural steel plate 166 and reinforced by ½″ thick structural steel plate 169, which is welded to frame 167. Frame 167 is welded to structural steel frame 154. A plurality of adjustment to air flow through said flexible plastic tube 103 and 163 which are monolithically connected are controlled by controller 291 located in control room 13.

It is contemplated that other embodiments may employ other than a plurality of plastic tubes 103 and 163, but tubes constructed from cellulose based paper or cotton fabric material. Another embodiment to wheel attachment 161 may employ a plurality of swivel wheels attached to the said rigid structural angled steel frame 154.

It is further contemplated that other than the plurality of the said pneumatic devices 165, a plurality of light stroboscopes and the like or stroboscopes similar to those utilized by police cars may be positioned for a plurality of use as distraction devices.

It is further contemplated that a plurality of distraction devices similar to the said pneumatic devices 165, may be attached to a plurality of side walls, or suspended by a plurality of hooks from the said roof 91, or from a plurality of support structures fixed to self sustained column means, capable of a plurality of positions within the cricket condition simulator.

The primary purpose for the distraction device is to provide a plurality of movements behind the bowler's arm at delivery of the cricket ball. Wicket keeper, batsmen and slip fielders and a plurality of players are forced to focus on the plurality of cricket balls delivered, for the period of distractions, during such plurality of live play. Similarly, and simultaneously, the activation of said distraction device 165 behind the wicket-keeper, would also persuade the bowler to focus on a plurality of cricket ball delivery tactics. The distraction may be intensified by the introduction of a plurality loud music, of familiar or unfamiliar melodies, as a plurality of diminished illumination above the cricket pitch is also introduced during live play. A plurality of combinations of such distractions, along with a plurality of induced environmental air thermodynamic changes, and a plurality of induced changes in cricket pitch conditions, during live practice sessions, form an integral component of the cricket condition simulator, in the use of a plurality of provisions of audio-visual means of reinforcing the concentration of a batsman, wicket keeper, bowler and fielder in a plurality of positions, during practice for competition.

Water storage tank 63 is equipped with 2″ diameter PVC pipe 65 which provides rain water from the roof 242 of the building envelope of the cricket conditions simulator; preferable source of operational and purified makeup water of municipality quality 66: float switch 67 to control a plurality of operational water levels: entrance and exit ladder 239; thermocouple temperature sensor 225; covered access opening 64: 2″ diameter PVC overflow discharge tube 292: submersible pump 81 and appurtenances to include 1″ diameter PVC water circulation tube 78 and 80, as well as a plurality of discharge atomizer nozzle 79; and 2″ diameter PVC pipe 250 to empty the said tank 63, if required, with submersible pump 249 and check valve 251.

Two chilled water storage tanks are provided with chilled return water storage tank 57, confined to processing water to the required operative temperature, and chilled supply water storage tank 60, acts as the receptacle from which chilled water could readily be supplied to aluminum plate 18 upon system demand. Chilled return water storage tank 57 is equipped with agitator 162 to mix already utilized chilled water from aluminum plate 18 with makeup chilled water from air condition/refrigeration unit (not shown); entrance and exit ladder 240; covered access opening 58; float switch 69 to control operational chilled water levels: thermocouple temperature sensor 233; 2″ diameter PVC outflow discharge pipe 171; 2″ diameter PVC chilled water supply pipe 62 from AC unit; 2″ diameter PVC spent chilled water return pipe 238 from aluminum plate 18; 2″ diameter chilled water return pipe 243 to air condition/refrigeration unit, with submersible pump 148 and check valve 211; 4″ thick thermal resistance insulation 244 enclosed in plastic moisture barrier (not shown); and 2″ PVC chilled water return pipe 245 to chilled supply water storage tank 60; with submersible pump 148 and check valve 212.

Chilled supply water storage tank 60 is equipped with agitator 59 to facilitate the prevention of thermal stratification in the said tank 60; 2″ chilled water supply pipe 231, with submersible pump 230 and check valve 210; entrance and exit ladder 241; covered access opening 61; float switch 68 to control operational chilled water levels; thermocouple temperature sensor 232; and 2″ diameter PVC 247 to empty both the said tanks 57 and 60, if required, with submersible pump 246 and check valve 248. It is contemplated the other than three separate fluid storage tanks 57, 60 and 63, a single tank with three compartments could be utilized, or two tanks to perform the function of three, thus eliminating the need for a third storage tank. It is further contemplated that said tank or any other tank considered could be constructed from a polymer.

Further considering the operation of the cricket conditions simulator device and process of the present invention, either rain water or water purified to municipal water quality is stored continuously in water storage tank 63 as shown in FIG. 3. A plurality of discharge pumps 173, 174 and 175 with suction ends in said tank 63, feed water through a plurality of respective check valves 176, 177 and 178, to a plurality of hot water heaters, which are also respectively identified as 47, 49 and 51, along a plurality of 1″ diameter aluminum tubes 46, 48 and 50. The said water heaters 47, 49 and 51 respectively supply hot water through a plurality of check valves 207, 208 and 209, along a plurality of 1″ diameter aluminum tubes 43, 44 and 45, to a plurality of respectively insulated hot water storage tanks 40, 41 and 42. Said hot water heaters supply hot water at a plurality of temperatures ranging from 20° C. to 40° C., whereas, the operational hot water plurality of temperatures ranges for said hot water heaters 49 and 51 are respectively 40° C. to 60° C. and 60° C. to 80° C.

Based upon the magnitude of the plurality of temperatures to be maintained in the sub-surface of the cricket pitch, either of the plurality of three discharge pumps 179, 182 or 184 is activated, since each is in communication with the plurality of thermocouples temperature sensors 22, located in aluminum plate 18. The flow of hot water from the said discharge pumps 179, 182 and 184 through a plurality of 1″ diameter insulated aluminum tubes 37, 38 and 39 are respectively controlled by a plurality of check valves 180, 181 and 183. A plurality of check valves 187, 185 and 186 are installed in the said aluminum tubes 37, 38 and 39 to control the plurality of flows of previously circulated hot water from returning to a plurality of respective discharge tubes 37, 38 and 39.

Referring to FIG. 3, hot water from a plurality of 1″ diameter insulated aluminum tubes 37, 38 and 39 are conveyed to a plurality of 1″ diameter insulated aluminum finned tube 26, which is welded continuously to aluminum plate 18 by 2″ diameter insulated aluminum tubing 55. Said aluminum tube 55 is connected to a plurality of 1″ diameter insulated aluminum tubes 28, 31 and 34, which in turn are each monolithically connected to the said 1″ diameter finned aluminum tube 26. A plurality of hot water flow along the said 2″ diameter insulated aluminum tube 55, is controlled by a plurality of check valves namely 191, 192 and 205. The plurality of hot water flow along the said intake 1″ aluminum tubes 28, 31 and 34 are respectively controlled by a plurality of check valves 201 and 203 on the said tubes 28, 198 and 199 on the said tubes 31, and 196 and 189 also on the said tubes 34.

The said finned tube 26 is supplied with hot water from said 2″ diameter insulated aluminum tube 55 through said separate supply tubes identified as 28, 31 and 34 for also respective zones I, II and II. The corresponding plurality of discharges ends of the said finned tube 26 are monolithically connected to a plurality of 1″ diameter insulated aluminum tubes 30, 33 and 36, which are all connected to a 2″ diameter insulated aluminum tube 52, which fixedly attached to the 2″ diameter insulated aluminum tubes 53 and 54. Hot water returning from said aluminum plate 18 is respectively controlled by a plurality of check valves 200, 216 and 194 on 1″ diameter tubes 30, 33 and 36.

More specifically the heat from the hot water which enters the said finned tube 26 from the said supply tubes 28, 31 and 34 and exits correspondingly at said discharge tubes 30, 33 and 36, is transferred to aluminum plate 18, which in turn in conjunction with the said finned tube 26, transfers the heat to the sub-surface medium of the cricket pitch. The goal here is to heat the subsurface medium to a temperature corresponding to the plurality of temperatures of the flowing hot water, thereby elevating the plurality of vapor pressure of the bound or any free moisture trapped within the cricket pitch 9.

The plurality of elevation in the moisture vapor pressure will facilitate a plurality of upward flow of moisture to the top surface of the cricket pitch 9, resulting in the plurality in general moisture content reduction in the cricket pitch 9. The required moisture content of the cricket pitch may be maintained by altering the plurality of heat content of the cricket pitch 9, relative to the thermodynamics of the atmosphere above the said cricket pitch. The plurality of moisture contents are monitored by use of a plurality of moisture content sensing probes 23, and such responses are recorded continuously on moisture content recorder 239. The plurality of thermocouples associated with this invention is used to monitor the plurality temperatures which are recorded continuously on temperature recorder 229.

Simultaneously, the vapor pressure of the air in contact with the cricket pitch 9 may be increased by elevating the relative humidity of the air, as a result of activating the micro-irrigation system, which includes sump pump 80, piping system 78 and atomizers 79.

A plurality of already used hot water from said aluminum plate 18 is transported from said 2″ diameter tube 52 to 2″ diameter tube 224 then returned to said water storage tank 63 for further processing.

Chilled water is conveyed from chilled water storage tank 60 to aluminum plate 18 by a network of pipe appurtenances to include sump pump 230; 2″ diameter insulated aluminum tube 231, along with a plurality of 1″ diameter insulated tubes 29, 32 and 35, with respective plurality of check valves 210, 202, 197 and 195: 2″ diameter insulated aluminum piping 56 with a plurality of check valves 204, 190 and 188 respectively to control chilled water to said zone I, II and III of the said aluminum plate 18. Chilled water flow to the said zone I from a plurality of 1″ diameter insulated aluminum tube 28 and 29 is further controlled by opening check valve 201 and closing check valve 203. With respect to the plurality of flow of chilled water to the said zone II by a combination of 1″ diameter insulated aluminum tubes 31 and 32, the plurality of chilled water flow is restricted on the 1″ diameter insulated aluminum tube 31 by check valve 197, but, check valve 198 on tube 31 is opened, as check valve 199 is opened. FIG. 3 shows chilled water flow to zone III is provided by a combination of 1″ diameter insulated aluminum tubes 34 and 35, and is further controlled by opening check valve 196 and closing check valve 189 which are both located on 1″ diameter insulated aluminum tube 34.

The heat in the cricket pitch 9 is transferred to the chilled water through the combination of the said 1″ diameter aluminum finned tube 26 and aluminum plate 18. Such an effect would reduce the plurality of temperatures of the cricket pitch as well as the plurality of vapor pressure of any moisture trapped within the said cricket pitch. Simultaneously, as the plurality of vapor pressure of the air in contact with the said cricket pitch is increased by elevating the relative humidity of the air, attributed to activating the said micro-irrigation system which includes sump pump 80, piping system 78 and atomizers 79, then because the plurality of vapor pressure of the air above the said cricket pitch is greater than that in the said cricket pitch, the moisture content in the said cricket pitch would increase by a plurality of amounts attributable to the plurality of vapor pressure differentials between that of the air above the said cricket pitch and that within the sub-surface of the said cricket pitch. The said thermocouples 22 located on aluminum plate 18 are utilized in conjunction with those identified as 234, 235 and 236 on respectively a plurality of 1″ diameter insulated aluminum tube 29,32 and 35: 237 on intake 2″ diameter insulated aluminum tube 56: 238 on 2″ diameter insulated and return aluminum tube 52: 221, 222 and 223 on a plurality of respective 1″ diameter insulated and return aluminum tubes 30, 33 and 36: 238 on 2″ diameter insulated and return aluminum tube 54: 232 and 233 on respectively chilled supply water storage tank 60 and chilled return water storage tank 57; to record a plurality of chilled water temperatures throughout the chilled water circulation system.

Chilled water which has passed through aluminum plate 18 is returned to storage tank 57 by the exiting the plurality of 1″ diameter insulated aluminum tubes 30, 33 and 36; then through 2″ diameter insulated aluminum tubes 52 and 54 as check valves 213 is closed. The chilled water return storage tank 57 is used as a receptacle, wherein a plurality of chilled water levels as determined by level sensor 69, and a plurality of temperatures as determined by thermocouple 233, are adjusted in a plurality of combinations, by respectively introducing, then mixed chilled water from the air condition/refrigeration unit with already used chilled water from aluminum plate 18, by use of agitator 162.

Once the plurality of desired temperature of chilled water is achieved, the said chilled water is transferred to chilled water storage tank 60 through the use of sump pump 160, gate valve 212 and tube 245; and essentially for a plurality of further use upon demand. Said storage tank 60 is also equipped with agitator 59 to prevent the occurrence of limnological stratification of temperatures within the said storage tank 60.

FIGS. 3 and 4 shows aluminum plate 18 is also equipped with a plurality of strain gages 21 to record the thrust of the cricket ball on impact to the said cricket pitch 9, thereby providing for a plurality of estimates of levels of cricket pitch deterioration, attributable to cricket ball warping compression stress on the said cricket pitch, relative to a plurality of other characteristic dimensionless factors' determinations, considering the plurality of status and other quality factors of the cricket pitch total environment. The plurality of impulses form strain gage data are recorded instantaneously by recorder 252, as required for a plurality of further use, to include the manipulation of the said dimensionless expression on cricket ball thrust as a direct function of thermal, geometrical, geotechnical, kinematic and geotechnical factors, as an integral component of this invention.

It is contemplated that other embodiments may provide additional gate valves on line 78 to isolate specific micro-irrigation nozzles.

It is further contemplated that other embodiments applied to said aluminum plate 18 may utilize no piping or a plurality of new piping arrangement with appurtenant means, considering heated air, heated solar air, other hot gases and those from combustion processes, steam, heated blanket, geothermal means, heated oil, dielectric or indirect electrical, micro wave and the like for heating the said cricket pitch.

It is further contemplated that other embodiments applied to said aluminum plate 18 may utilize no piping or a plurality of new piping arrangement with appurtenant means, considering various industrial coolants such as ethylene glycol and the like, carbon dioxide, modified cryogenic means, dry ice, evaporative cooling means, water from considerable depths of rivers, streams and lakes and the like for cooling the said cricket pitch.

A plurality of high sensitivity cameras 140 and 147 respectively attached along the longitudinal ridge of the roof, and about the lowest of a plurality of stairs associated with the spectator observation stand 145, as well as at ground level of the said simulator, to record a plurality of real time practice activities, considering a plurality of bowlers run up velocities, cricket ball height above the cricket pith at delivery; a plurality of distance traveled by cricket ball between delivery point and impact point; a plurality of cricket ball delivery velocities prior to impact on the cricket pitch; a plurality of cricket ball attack velocities after impact on the cricket pitch; a plurality of cricket ball impact area to coordinate with the plurality of data collected by strain gages 21 located on the aluminum plate 18; a plurality of cricket ball alignment prior and after impact on the cricket pitch within the said cricket conditions simulator, and the plurality of such data sets may be utilized by coaches, cricketers and other authorized personnel for a plurality of further and detailed scientific analysis. Camera 140 is located at a plurality of elevated distances immediately and above the cricket pitch. Said camera has the capability to record a plurality of visible formation and or appearance of a plurality of cracks on the cricket pitch surface over time.

Central control room 13 is equipped with a plurality of control and recording mechanisms to include those associated operatively control music to speakers 149, cameras 140 and 147 controller 266, spray boom 87 controller 279, fans 5 controller 274, mist atomizers 14 controller 323; strain gage recorders 252, moisture content recorders 239, thermocouple recorders 229, visual distracter controller 265, mist atomizers from micro irrigation system 79 controller 321, the position of wind deflectors 139, levels of cricket conditions simulator illumination from 16, wet bulb and dry bulb temperature recorders 267, relative humidity recorders 268, strain gage recorders 252, moisture content recorders 239, thermocouple recorders 229, and wind velocity recorder 264.

The air conditioning/refrigeration units 254 are sized between 170 tons to 200 tons with corresponding domestic quality water requirements of respectively 510 to 600 gallons per minute to provide for a plurality of outdoor conditions on as needed basis.

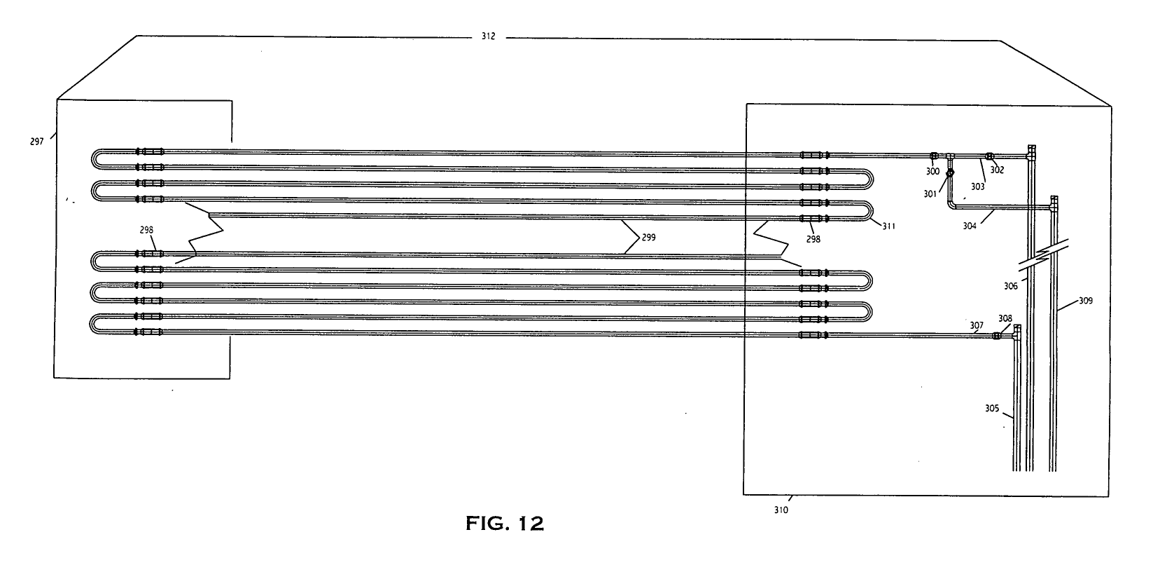

FIG. 1 shows a 12′ wide strip of natural ground is covered with vegetation variety Kentucky Blue or Fescue and the like for bowler's run up lane 294 and is provided on either side of the narrow ends of the said cricket pitch. All other open terrain within the cricket conditions simulator is covered with asphalt concrete 321, upon which synthetic turf material 322 common to indoor sporting facilities are installed, to reduce maintenance costs. It is contemplated that other embodiments utilized soil and grass for all other open terrain cover, or a combination of concrete slab 4 and synthetic turf material. It is further contemplated that another embodiment may include an above ground or below ground irrigation system be installed specifically for the said lane 294. With reference to FIG. 12, tubes 306 and 309 respectively provide hot and chilled water for a plurality of desired temperature to the said cricket pitch.

Each cricket conditions simulator is different with respect to operating conditions, and has to be calibrated to determine the plurality of cricket pitch constants and a plurality of weather constants, in addition to a plurality of distractions levels to include those associated with audio, illumination and pneumatic levels, and that information incorporated into a curriculum, and explained to cricketers in a plurality of easy to digest format by coaches and other counseling personnel, prior to or during practice sessions. The cricket conditions simulator is an education developmental tool that has a plurality of operation merits similar to a medical surgical operating theater, in that the said surgical theater is available throughout the day, except for maintenance. The extension is that practice sessions can be scheduled during any time of the day including 1:00 am or 3:00 am, based upon availability of units, and coaches schedules, given it is contemplated as an embodiment to include eye hand coordination support sports such as badminton, table tennis, racket ball and golf; swimming, auditorium as an integral component of the said cricket conditions simulator.

Existing indoor and outdoor pitches could be retrofitted in such a manner to facilitate the introduction of a standards with respect to quality of cricket pitches, considering the international community, plurality of cricket pitch moisture content control, plurality of cricket pitch temperature and plurality of levels of cricket pitch compaction. To satisfy such objective the said aluminum plate 18 is modified by omitting the entire said aluminum plate 18. FIG. 12 shows a new heating and cooling means 312 to include a plurality of aluminum tubes 299, a plurality of lock and sleeve means 298, a plurality of hot water tubes 306 and 303, a plurality of chilled water tubes 301 and 309 and a plurality of return water tubes 305 and 307; and plurality of curved sections 311. Tube 305 transports water from the cricket pitch to the said chiller, and tubes 306 and 309 respectively provide hot and chilled water of desired plurality of temperatures to the cricket pitch. Both hot water heater and chilled water conditioning unit are not shown. The retrofitting process on the cricket pitch may be accomplished by installing a plurality of heating and cooling tubes below the top surface of the existing cricket pitch, by use of industrialized micro-tunnel equipment to construct the plurality of tunnels to a desired depth below the existing cricket pitch. Said aluminum tubes 299 are pulled through into operational position within the said tunnels. The plurality of straight tubes 299 are fixedly connected to said plurality of curved aluminum tubes 311. The plurality of other tubes are connected into a net work as shown in FIG. 12. The plurality of ranges of tube sizes could vary respectively from ½″ to 4″ for tubes 299 and 311; 1″ to 6″ for tubes 304, 309, 303, and 306; and 1′ to 2″ for tubes 305 and 307.

Another embodiment to the said heating and cooling means 312 is the use of hot air, or hot oil or electrical energy means as the heating source.

Yet another embodiment to the said heating and cooling means 312 may include the construction of a reinforced concrete beam along and below the said curved section 311 for structural support.

A further embodiment to the said heating and cooling means 312 may include the construction of a plurality of sub-surface French drains, at designed distance from the cricket pitch, to assist with ground water flow, about and below the cricket pitch.

Yet another embodiment to the said heating and cooling means 312 may include the positioning of the hot water heater and chiller, either about the cricket pitch or off the cricket ground, preferable under a spectator stand or in and or about the club house.

A further embodiment to the said heating and cooling means 312 and considering claim 40, may include the construction of a reinforced concrete beam, and or reinforced concrete slab singularly, or in combination of said slab and said beam, under the curved section of the said heating and cooling means 312, for a plurality of structural support.

A further embodiment to the said heating and cooling means 312 and considering claim 41, may include the construction of a reinforced concrete beam and or reinforced concrete slab singularly, or in combination of said slab and said beam within the said underground means as described in claim 1, and under the said heating and cooling means 312, for a plurality of structural support and a plurality of access means for maintenance.

It is further contemplated that other embodiments applied to said heating and cooling means 312 and considering claim 41, may include the construction of a reinforced concrete slab with shallow vertical reinforced concrete walls, monolithically or integrally attached to the top surface of the perimeter of the said slab; with the plurality of heating and cooling means described herein in contact with, or within 6″ of the top or bottom surface of the said concrete slab of the said heating and cooling means 312.

It is further contemplated that other embodiments applied to said heating and cooling means 312 and considering claim 41, may include the construction of a high temperature resistant plastic slab with shallow vertical high temperature resistant plastic reinforced walls monolithically or integrally attached to the top surface of the perimeter of the said slab; with the plurality of heating and cooling means described herein in contact with or within 6″ of the top or bottom surface of the said high temperature resistant plastic slab.

It is further contemplated that other embodiments applied to said heating and cooling means 312 and considering claim 41, may include the construction of copper or plastic or other polymer coated galvanized sheet metal slab, with respectively shallow vertical copper or plastic or other polymer coated galvanized sheet metal walls, monolithically or integrally attached to the top surface of the perimeter of the said slab; with the plurality of heating and cooling means described herein in contact with or within 6″ of the top or bottom surface of the said copper or plastic or other polymer coated galvanized sheet metal slab.

Referring to FIG. 12, it is further contemplated that other embodiments applied to said heating and cooling means 312 and considering claim 41, may utilize a plurality of said tube 299 as a central distributor, from which a plurality of tubes functioning as arms protruding perpendicular to or at a plurality of angles from the said tube 299; said arms may terminate at the exit tube 307, or may connect to a plurality of other such central distributor tubes prior to termination at the exit tube 307.

Referring to FIG. 12, it is further contemplated that other embodiments applied to said heating and cooling means 312 and considering claim 41, may utilize said tube 299 as a doughnut from which a plurality of tubes functioning as arms protruding, perpendicular to or at a plurality of angles from the said tube 299; said arms may terminate at the exit tube 307, or may connect to a plurality of other such central distributor tubes prior to termination at the exit tube 307.

It is further contemplated that other embodiments applied to said heating and cooling means 312 and considering claim 41, may include the construction of a plurality of hybrid combination of a plurality of metals of different properties, as well as plastic slab with a plurality of shallow vertical of a plurality of hybrid combination of metals of different properties, as well as plastic walls, monolithically or integrally attached to the top surface of the perimeter of the said slab; with the plurality of heating and cooling means described herein, in contact with or within 6″ of the top or bottom surface of the said hybrid combination of metals, with a plurality of different properties, as well as plastic slab.

It is further contemplated that other embodiments applied to the said building structure considering claim 42 may utilize a plurality of different roof configuration to include the curved doomed, flat type with mild slope; plurality of vertical external walls of different textural configuration and construction, and appearance; lobby area at the entrance; mural for the facility at the entrance or any other geometric position relative to the said building structure 1; detached means from the main cricket conditions simulator for a plurality of different combination for cafeteria, dormitory, administration, auditorium, gift shop, museum, gymnasium, coaches lounges, eye hand coordination means; grass cover for all terrain between safety protection net 7 and the said cricket pitch; plurality of side walks for building approach; plurality of internet access and a plurality of other communication means; location of atrium at any geometric position in the said building; one fast bowler run up lane only that could be used by other bowlers, as a shorter lane in distance on the opposite side of the cricket pith may be utilized for spinners only; use of mechanized bowlers and the like.

It is further contemplated that other embodiments considered the positioning of two said aluminum plates 18 on a 22 yards cricket pitch, with each of aluminum plate 18 located at each end of the said cricket pitch.

It is further contemplated that other embodiments considered the said building structure 1 with appurtenances described herein, may be designed to accommodate a plurality of combination of lengthy fast bowlers run up lanes, medium pace fast bowlers run up lanes and spinners short run up lanes, along with a plurality of single or double said aluminum plate 18 and or a plurality of other heating means described herein.

It is further contemplated that other embodiments considered a plurality of environmental adjustments, concepts with associated processes, equipment, building structure and the like as described herein to be applied to a plurality of golf course putting greens and a plurality of sand traps rating determinations, considering stimpmetre.

While the preferred embodiments of the present invention have been disclosed and described, it is understood that many aspects may be altered without deviating from the underlying conceptualization of this invention.

We claim:

1. A process wherein cricket conditions simulator is included to enhance the performance in batting, fielding and bowling for cricket, by providing opportunities to acquire advanced knowledge on the inter relationships among the identified variables of cricket playing environment, to include the relationship among cricket ball impact thrust relative to the thermodynamics and velocity of the air, the cricket ball thermal heat transfer constants and thermodynamics properties, inertial, and aerodynamics characteristics; and the cricket pitch thermal heat transfer constants, thermodynamics, geotechnical, rheological, and agronomic properties adjustment, by varying the moisture content and temperature of the cricket pitch as well as the air velocity, temperature and relative humidity comprising:
a) heating or cooling the subsurface of the cricket pitch by a combination of aluminum finned tubes and aluminum plate located in an horizontal position beneath the said cricket pitch;
b) monitoring and recording simultaneously the cricket ball thrust, temperature and moisture content associated therewith in a multiplicity of respectively strain gages, thermocouples and moisture content sensors; said strain gages, thermocouples and moisture content sensors are connected to strain gages temperature and moisture content recorders.

2. A process of heating and cooling the subsurface of the cricket pitch as in claim 1 wherein said process utilized hot water as the heat transfer medium.

3. A process of heating and cooling the subsurface of the cricket pitch as in claim 1 wherein said process utilized an air condition system to produce a plurality of temperatures and the relative humidity of the air.

4. A process of heating and cooling the subsurface of the cricket pitch as in claim 1 wherein said process utilized a water atomizer nozzle to produce a plurality of moisture contents of the air, hence the relative humidity of the air, as well as for direct application of water to the cricket pitch.

5. A process of heating and cooling the subsurface of the cricket pitch as in claim 1 wherein said process utilized high speed fans to produce a plurality of velocities and directions of the air.

6. A process of heating and cooling the subsurface of the cricket pitch as in claim 1 wherein said process utilized a pivoted spray boom with spray nozzles to add a plurality of required moisture to the cricket pitch.

7. Apparatus for heating and cooling the subsurface of the cricket pitch as in claim 1 wherein said process utilized a single plate with a plurality of perforations to accommodate strain gages fixedly secure to the underside of inverted receptacles, constructed from aluminum.

8. Apparatus for heating and cooling the subsurface of the cricket pitch as in claim 1 wherein said process utilized a single plate with a plurality of perforations to accommodate moisture content probes; said sensors of the said moisture probes extend to different depths from the underside into the subsurface of the said cricket pitch.

9. Apparatus for heating and cooling the subsurface of the cricket pitch as in claim 1 wherein said process utilized a single plate with a plurality of perforations to accommodate thermocouples.

10. Apparatus for heating and cooling the subsurface of the cricket pitch as in claim 1 wherein said process utilized a single plate upon which a plurality of finned tubes are welded continuously and horizontally along each side on to the said plate, so as to form a single heating and cooling unit.

11. Apparatus for heating and cooling the subsurface of the cricket pitch as in claim 1 wherein said process utilized a single plate which is supported on its perimeter and central sections by respectively metal frame and intermediate support metal plates located about and under side of the interior of the said metal plate; said support metal plates made from material of similar type as that of the said plate, are joined together by a plurality of continuous weldments along each side to the said single plate.

12. Apparatus for heating and cooling the subsurface of the cricket pitch as in claim 1 wherein said process utilized a plurality of metal brackets which act as platform to support the rigid material which supports the thermal insulation on the underside of the said single plate; said brackets are secured to he said metal supports by continuous weldments.

13. Apparatus for heating and cooling the subsurface of the cricket pitch as in claim 1 wherein said process utilized a reinforced concrete structure to provide support for the said metal frame and said interior supports for the said single plate.

14. Apparatus for heating and cooling the subsurface of the cricket pitch as in claim 1 wherein the said process utilized flexible thermal insulation on the underside, as well as to the perimeter sides of the of the said single plate, and to the sides of the said perimeter and interior support metal plates.

15. Apparatus for heating and cooling the subsurface of the cricket pitch as in claim 1 wherein the said process utilized a plurality of metal tubes to convey water to and from the said single plate.

16. Apparatus for heating and cooling the subsurface of the cricket pitch as in claim 1 wherein the said process utilized a plurality of control valves to control the flow of water to and from the said single plate.

17. Apparatus for heating and cooling the subsurface of the cricket pitch as in claim 1 wherein said process utilized a plurality of pumps to convey water to and from the said single plate.

18. Apparatus for heating the subsurface of the cricket pitch as in claim 1 wherein the said process utilized a fluid storage tank capable of accepting rain or water of municipality drinking water quality and water previously circulated throughout the said single plate; said fluid storage tank is equipped with access ladder: access cover: fluid level switch: thermocouple: plurality of supply piping to hot water heaters; agitator for mixing fluids; overflow discharge piping: plurality of piping, submersible pump and check valve for micro-irrigation system: return pipe from said single metal plate and thermal insulation.

19. Apparatus for heating the subsurface of the cricket pitch as in claim 1 wherein said process utilized a plurality of hot water heaters; said water heaters supply hot water to the said single plate.

20. Apparatus for heating the subsurface of the cricket pitch as in claim 1 wherein said process utilized a plurality of hot water heaters storage tanks. Said hot water storage tanks are connected to the said hot water heaters by a plurality of 1″ diameter insulated tubes.

21. Apparatus for cooling the subsurface of the cricket pitch as in claim 1 wherein the said process utilized a fluid storage tank capable of accepting chilled circulated water; said fluid storage tank is equipped with access ladder: access cover: fluid level switch: thermocouple: overflow discharge piping: plurality of piping, agitator; submersible pump and check valve for discharge into another fluid storage tank: thermal insulation; plurality of piping, submersible pump and check valve for discharge to AC chiller water unit; and AC chilled water supply pipe.

22. Apparatus for cooling the subsurface of the cricket pitch as in claim 1 wherein the said process utilized a fluid storage tank capable of accepting chilled water from fluid storage tank capable of accepting chilled circulated water; said fluid storage tank is equipped with access ladder: access cover: fluid level switch: thermocouple: overflow discharge piping: plurality of piping, agitator; submersible pump and check valve for discharge to the said single metal plate; and thermal insulation.

23. Apparatus for heating and cooling the subsurface of the cricket pitch as in claim 1 wherein the said process utilized a plurality of passageways under the said cricket pitch, to access the maintenance of thermocouples, moisture sensors, strain gages thermal insulation, metal supporting brackets, electrical signal conductors joining means between thermocouples, moisture sensors, strain gages; walls and floor of the said passageways are constructed of reinforced concrete.

24. Apparatus for heating and cooling the subsurface of the cricket pitch as in claim 1 wherein the said process utilized a plurality of rectangular gravity flow floor drains and receptacle, suction and discharge piping, valves, and sump pump means to remove fluids from the said passageways and sub-surface structure for said hot water heaters.

25. Apparatus for heating and cooling the subsurface of the cricket pitch as in claim 1 wherein the said process utilized a plurality of opening means to provide for natural convective air flow within and across the said passageways; said openings are rectangular in shape.

26. Apparatus for heating and cooling the subsurface of the cricket pitch as in claim 1 wherein said process utilized a plurality of electrical lighting and switch control means in the said passageways.

27. Equipment for cooling the surface of the cricket pitch as in claim 1 wherein the said process utilized a pivoted spray boom; said spray boom is constructed with structural steel welded into a rigid frame supported by wheel means to transport the said frame.

28. Equipment for cooling the surface of the cricket pitch as in claim 27 wherein the said process utilized a plurality of spray nozzles fluid dispensers with control valves, fluid transport piping and pressure induced fluid pump means to discharge control quantities of fluid on the top surface of the said cricket pitch; the suction side of the said fluid pump is connected to fluid tank.

29. Equipment with a plurality of visual distraction means for building mental concentration during batting, fielding and bowling practice; the rigid frame for said equipment is constructed from structural steel angles, secured together by a plurality of weldments.

30. Equipment with a plurality of visual distraction means for building mental concentration during batting, fielding and bowling practice in claim 29 is supported on commercial type wheels; said equipment consists of equally spaced flexible circular tubes oriented in vertical positions and mechanically attached to a rigid circular tube oriented in horizontal position; said tube in horizontal position is connected to the discharge of a motor driven fan secured to the said rigid frame, and is also equipped with large equally spaced plurality of orifices joined to protruding plurality of extensions oriented in vertical positions, to accommodate the mechanical attachment means of the said plurality of flexible tubes.

31. Equipment with a plurality of visual distraction means for building mental concentration during batting, fielding and bowling practice in claim 29 has a hitching pin to facilitate transport of the said equipment to a plurality of different locations.

32. Equipment with a plurality of audible distraction means for building mental concentration during batting, fielding and bowling practice; said equipment consists of a plurality of sound producing stereophonic means and control of sound levels of music, chants, roars, utterances and the like of a plurality of different cultural affiliations, as the cricket pitch is heated or cooled by the said single plate.

33. Equipment with a plurality of visual distraction means for building mental concentration during batting, fielding and bowling practice; said equipment comprises means to control a plurality of variable illumination intensity, attached to ceiling or supported by other fixed structures to facilitate playing cricket under a plurality of different day and night light conditions as the cricket pitch is heated or cooled by the said single plate.

34. Apparatus for heating and cooling the subsurface of the cricket pitch as in claim 1 wherein the said process utilized sub-surface reinforced concrete enclosure for a plurality of hot water heaters with corresponding plurality of insulated hot water storage tanks.

35. Apparatus for heating the subsurface of the cricket pitch as in claim 2 wherein the said process utilized hot water heaters to provide heated water; the plurality of said hot water heaters are connected to corresponding plurality of insulated hot water storage tank.

36. Equipment to determine a plurality of relative humidity above cricket pitch by determining wet bulb temperature and dry bulb temperature for use on psychometric means, as said pitch is heated and cooled by said single plate.

37. Equipment to determine the formation of plurality of cracks in cricket pitch as the cricket pitch is heated and cooled by said single plate during practice; said equipment consist of high speed cameras attached to a controller.

38. Equipment to determine plurality of relative humidity above cricket pitch by direct meter measurement; said equipment is attached to recorder as the said pitch is heated and cooled by said single plate.

39. A plurality of variables to be placed singularly or in plurality of groups of dimensionless quantities within a plurality of dimensionless expressions, to describe the plurality of relationships for cricket ball dimensionless thrust prior to, at, and after to impact to cricket pitch, considering the plurality of dimensionless cricket ball delivery velocity, bowlers approach velocity, velocity of cricket ball after impact, a plurality of thermal, aerodynamic and thermodynamic properties of the cricket ball, plurality of the thermodynamics and velocity of the air, as well as the plurality of cricket pitch geometrical, thermal constants, soil geotechnical, thermodynamics, and rehological properties.

40. Equipment to retrofit existing cricket pitches to cause to experience a plurality of desired levels of moisture content, temperature and compaction levels; said equipment is equipped with plurality of aluminum heating and cooling tubes: a plurality of flow control valves: water heater: chiller: plurality of pumps: a plurality of wind velocity, temperature and relative humidity sensors and moisture probes with respective plurality of recorders: and optional construction of reinforced concrete beams or reinforced concrete slab under the plurality of curved sections of the said tubes.

41. Equipment for installation under new cricket pitches to cause to experience a plurality of desired levels of moisture content, temperature and compaction levels; said equipment is equipped with plurality of aluminum heating and cooling tubes: a plurality of flow control valves: water heater: chiller: a plurality of pumps: micro-irrigation system (not shown); a plurality, of wind velocity, temperature and relative humidity sensors and moisture probes with respective plurality of recorders: optional construction of reinforced concrete beams or reinforced slab and or underground means for access and maintenance as in claim 1.

42. A building structure with a plurality of insulation of special type and thickness, wherein a plurality of rooms to include cafeteria, dormitory, class rooms, administration, coaches lounges, gymnasium, observation decks, spectator bleachers, audiovisual rooms and the like are simultaneously utilized by the cricket conditions simulator to enhance the performance in batting, fielding and bowling for cricket, by providing opportunities to acquire a plurality of general and advanced knowledge on the inter-relationships among the identified variables of cricket playing environment, to further include the simultaneous plurality of relationships among cricket ball impact thrust relative to the plurality of the thermodynamics and velocity of the air, the plurality of the cricket ball thermal heat transfer constants and thermodynamics properties, inertial, and aerodynamics characteristics; and the plurality of the cricket pitch thermal heat transfer constants, thermodynamics, geotechnical, rheological, and agronomic properties adjustment, by modifying the plurality of the moisture content and temperature of the cricket pitch as well as the plurality of air velocity, temperature and relative humidity.

43. An approach within claim 39 to estimate the plurality of the levels of cricket pitch deterioration relative to the plurality of the cricket pitch compaction density, moisture content, temperature and frequency and the plurality of the magnitudes of induced vibrations.

44. Equipment as in claim 1 and 39 with the plurality of capabilities to replicate a plurality of cricket playing conditions; said conditions considered a plurality of outdoor temperature and relative humidity, illumination, visual and spectator cultural sounds as distractions, a plurality of wind speeds, as a plurality of cameras record the formation of the plurality of cracks in the cricket pitch, and estimate the plurality of cricket ball velocities; and a heat exchanger equipped with plurality of pressure sensors, plurality of heating and cooling fluid means, and located within a cricket pitch equipped with a plurality of temperature and moisture content sensors, to produce a plurality of cricket pitch conditions.

45. Equipment as in claim 1 and 39 with the plurality of capabilities to establish weather and cricket pitch constants for a plurality of cricket playing conditions; said conditions considered a plurality of outdoor temperature and relative humidity, illumination, visual and spectator cultural sounds as distractions, a plurality of wind speeds to a maximum wind speeds, as cameras record the formation of cracks in cricket pitch and estimate the plurality of cricket ball velocities; and a heat exchanger equipped with pressure sensors, heating and cooling fluid, and located within a cricket pitch equipped with a plurality of

46. temperature and moisture content sensors, to produce a plurality of cricket pitch conditions.

47. Equipment as in claim 1 and 39 with the plurality of capabilities to be used as an educational tool by and to benefit a plurality of governments, private and industrial organization, cricketers, coaches, cricket administrators, cricket counseling personnel, cricket enthusiasts and non cricket enthusiasts for a plurality of cricket playing conditions; said conditions considered a plurality of outdoor temperature and relative humidity, illumination, visual and spectator cultural sounds as distractions, a plurality of wind speeds to a maximum wind speed of 50 miles per hour, as cameras record the formation of cracks in cricket pitch and estimate a plurality of cricket ball velocities; and a heat exchanger equipped with a plurality of pressure sensors, heating and cooling fluid, and located within a cricket pitch equipped with a plurality of temperature and moisture content sensors, to produce a plurality of cricket pitch condition.
